(19) United States
(12) Patent Application Publication
(10) Pub. No.: US 2018/0270329 A1
(43) Pub. Date: Sep. 20, 2018

(54) NODE APPARATUS, WIRELESS NETWORK SYSTEM, AND LIGHT EMITTING METHOD IN NODE APPARATUS FOR VISUALIZING COMMUNICATION PATH

(71) Applicant: FUJITSU LIMITED, Kawasaki-shi (JP)

(72) Inventors: Katsumi SAKURAI, Kamo (JP); Masataka Sato, Yokohama (JP); Yuji TAKAHASHI, Minato (JP)

(73) Assignee: FUJITSU LIMITED, Kawasaki-shi (JP)

(21) Appl. No.: 15/911,466

(22) Filed: Mar. 5, 2018

(30) Foreign Application Priority Data
Mar. 15, 2017 (JP) 2017-050618

(51) Int. Cl. H04L 29/08; H04L 12/24; G08B 5/36

(52) U.S. Cl. CPC H04L 67/36; H04W 84/18; G08B 5/36; H04L 41/12

(57) ABSTRACT

A method for visualization of a communication path includes: executing, by a processor of the node apparatus, a wireless communication processing that includes receiving a first frame transmitted wirelessly from a first node apparatus or a terminal apparatus, the first frame including first time information indicating a timing to cause the light emitting device to emit light, and performing at least either one of processing to utilize the path information to transmit the received first frame to a second node apparatus according to the path information and processing to terminate the received first frame according to the path information; executing, by the processor of the node apparatus, an application processing that includes causing the light emitting device to emit light, based on the first time information included in the first frame.

### CROSS-REFERENCE TO RELATED APPLICATION

This application is based upon and claims the benefit of priority of the prior International Patent Application No. 2017-050618, filed on Mar. 15, 2017, the entire contents of which are incorporated herein by reference.

### FIELD

The embodiments discussed herein are related to a node apparatus, a wireless network system, and a light emitting method in the node apparatus for visualizing a communication path in wireless communications.

### BACKGROUND

Conventionally, a wireless network system has sometimes been built through ad-hoc communications. The ad-hoc communications are a communication method in which a node apparatus builds a path in an autonomous-distributed manner without going through a base station or an access point, for example, and performs wireless communications by utilizing the built path. The ad-hoc communications are also a communication technology in an autonomous-distributed wireless network, for example.

In recent years, the ad-hoc communications are also utilized in the field of IoT (Internet of Things) in some cases. For example, it is also possible that a sensor with a wireless communication function is mounted in a gas meter or the like, a wireless network system is built in an autonomous-distributed manner through the use of the ad-hoc communications, and values measured by the sensor are transmitted to a server apparatus by way of a plurality of sensors.

On the other hand, in the field related to communications, there are following technologies, for example.

There is an information visualization apparatus that includes: a rectifier circuit configured to receive a differential signal transmitted to a LAN cable wire and convert it into a direct voltage; and a light emitting circuit configured to emit light when the direct voltage is supplied, and that emits light only while a LAN cable is communicating information.

It is said that this technology makes it possible to visually confirm at a low cost and with ease whether or not there is information communication in a communication cable.

In such an information visualization apparatus, there is also another technology that includes: an antenna configured to receive electromagnetic energy transmitted from a wireless power supply apparatus; and a rectifier circuit configured to rectify the electromagnetic energy received by the antenna to generate a direct voltage, and that operates with the direct voltage generated by the rectifier circuit as an operating power source.

It is said that this technology makes it possible to visually confirm whether or not there is any information communication in a communication cable and to avoid the communication cable being pulled out inadvertently.

There is also a light-emitting toy that includes a three-axis acceleration sensor provided at a tip and that controls lighting of a plurality of LEDs based on acceleration data in directions of an X-axis, a Y-axis, and a Z-axis detected by the acceleration sensor.

It is said that this technology makes it possible to provide a light-emitting toy that is capable of changing the color and mode of an emitted light, depending on a swing operation of a user or the like.

Examples of the related art include Japanese Laid-open Patent Publication No. 2016-35427, Japanese Laid-open Patent Publication No. 2016-35697, Japanese Laid-open Patent Publication No. 2001-347080.

### SUMMARY

According to an aspect of the invention, a method for visualization of a communication path includes: executing, by a processor of the node apparatus, a wireless communication processing that includes receiving a first frame transmitted wirelessly from a first node apparatus or a terminal apparatus, the first frame including first time information indicating a timing to cause the light emitting device to emit light, and performing at least either one of processing to utilize the path information to transmit the received first frame to a second node apparatus according to the path information and processing to terminate the received first frame according to the path information; executing, by the processor of the node apparatus, an application processing that includes causing the light emitting device to emit light, based on the first time information included in the first frame.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of a wireless network system;

FIG. 2 is a diagram illustrating a configuration example of a node apparatus;

FIG. 3 is a diagram illustrating a configuration example of a terminal apparatus;

FIG. 4 is a diagram illustrating a hardware configuration example of the node apparatus;

FIG. 5 is a diagram illustrating a hardware configuration example of the terminal apparatus;

FIG. 6 is a diagram illustrating a correspondence relationship example of a color number and a RGB value;

FIG. 7A is a diagram illustrating an example of three axes and FIG. 7B is a diagram illustrating an example of a detectable operation, respectively;

FIG. 8A is a diagram illustrating a frame configuration example, and FIG. 8B is a diagram illustrating a configuration example of a header area, respectively;

FIGS. 9A and 9B are diagrams illustrating a frame transfer example, respectively;

FIGS. 10A and 10B are diagrams illustrating a frame transfer example, respectively;

FIG. 11 is a diagram illustrating an example of state transition of a demo-pattern;

FIG. 12A is a diagram illustrating a demo-pattern set request frame, and FIG. 12B is a diagram illustrating transfer examples of the demo-pattern set request frame, respectively;

FIG. 13 is a diagram illustrating a frame transfer example with a MAC filter;

FIG. 14 is a diagram illustrating a path-demo example;

FIG. 15A is a diagram illustrating a configuration example of a LED transfer instruction frame, and FIG. 15B is a diagram illustrating transfer examples of the LED transfer instruction frame, respectively;

FIG. 16 is a flow chart illustrating an example of a LED lighting instruction frame reception process;

FIG. 17 is a diagram illustrating a path-demo example;

FIG. 18 is a diagram illustrating a path-demo example;

FIG. 19A is a diagram illustrating a configuration example of a state notice frame, and FIG. 19B is a diagram illustrating respective transfer examples of the state notice frame;

FIG. 20 is a flowchart illustrating an example of light emission processing;

FIG. 21 is a flowchart illustrating an example of the state notice frame reception processing;

FIGS. 22A and 22B are diagrams illustrating a Mesh-demo;

FIGS. 23A and 23B are diagrams illustrating a Mesh-demo;

FIG. 24A is a diagram illustrating a configuration example of a Mesh-demo execution frame, and FIG. 24B is a diagram illustrating a transfer example of the Mesh-demo execution frame;

FIG. 25 is a flowchart illustrating an example of light emission processing;

FIGS. 26A and 26B are flowcharts illustrating an example of Mesh-demo execution frame reception processing;

FIGS. 27A and 27B are diagrams illustrating an example of 1hop-demo;

FIGS. 28A and 28B are diagrams illustrating an example of 1hop-demo;

FIG. 29 is a diagram illustrating a relationship example of coordinates and addresses;

FIG. 30A is a diagram illustrating a configuration example of a 1hop-demo execution frame and FIG. 30B is a diagram illustrating a transfer example of the 1hop-demo execution frame, respectively;

FIG. 31 is a flowchart illustrating an example of light emission processing;

FIG. 32 is a flowchart illustrating an example of the 1hop-demo execution frame reception processing;

FIG. 33A is a diagram illustrating a configuration example of a restart request frame and FIG. 33B is a diagram illustrating transfer examples of the restart request frame, respectively; and

FIG. 34 is a diagram illustrating a configuration example of a wireless network system.

### DESCRIPTION OF EMBODIMENTS

The information visualization apparatus as described above is designed such that a rectifier circuit or a light emitting circuit is connected to each one of physical communication cables. Therefore, even though the above-mentioned information visualization apparatus is capable of visualizing a communication path in wired communications, the information visualization apparatus is not capable of visualizing a communication path in wireless communications.

In addition, the light-emitting toy as described above is designed to emit light depending on a swing operation of a user who uses the light-emitting toy, and is not capable of visualizing a communication path in wireless communications to be transmitted in wireless communications and causing the communication path to emit light.

In one aspect of the present description, provided are technologies for visualizing a communication path in wireless communications.

Hereinafter, this embodiment is described in detail with reference to the drawings. Problems and examples in this specification are one example and do not limit a range of rights of this application. In particular, even if expressions in the description differ, technologies in this application are applicable and do not limit the range of rights as far as the technologies are equivalent. Then, it is possible to combine respective embodiments appropriately as far as they do not contradict with content of processing.

In addition, for terms and technical contents stated in specifications, those stated in specifications as communication standards such as Request for Comments (RFC) or The Institute of Electrical and Electronic Engineers (IEEE) or the like may be appropriately used.

### First Embodiment

<Configuration Example of Wireless Network System>

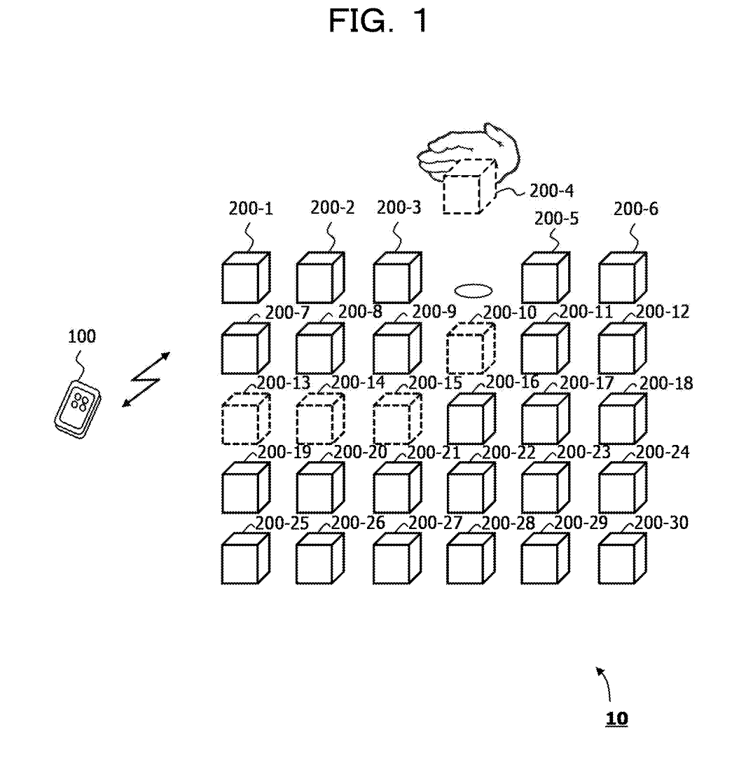

FIG. 1 is a diagram illustrating a configuration example of a wireless network system 10 in this first embodiment. The wireless network system 10 includes a terminal apparatus (which may be hereinafter referred to as a “terminal”) 100 and a plurality of node apparatuses (which may be hereinafter referred to as “nodes”) 200-1 to 200-30.

The terminal 100 may be a wireless communication apparatus such as a smart phone, a feature phone, a tablet terminal, a personal computer, a game apparatus or the like. The terminal 100 may transmit various instructions such as an instruction to light up to any of the plurality of nodes 200-1 to 200-3. The terminal 100 may also receive information indicating in what color of light each of the nodes 200-1 to 200-30 emits, or the like, from any of the plurality of nodes 200-1 to 200-30.

The plurality of nodes 200-1 to 200-30 may wirelessly communicate with each other, build a path in an autonomous-distributed manner by utilizing ad-hoc communications, and transmit and receive a radio signal along the built path. For this reason, the plurality of nodes 200-1 to 200-30 stores path information in a memory or the like, and may transmit the radio signal to other node. Autonomous decentralization refers to transmission and reception of a radio signal without going through a base station apparatus or an access point, and according to path information that indicates a path built by each of the nodes 200-1 to 200-30.

Furthermore, a method for each of the nodes 200-1 to 200-30 to build a path may be a publicly known method. In this first embodiment, a description is provided, assuming that the plurality of nodes 200-1 to 200-30 already build paths and retain path information in a memory or the like.

In addition, each of the plurality of nodes 200-1 to 200-30 internally includes a light emitting unit such as a Light Emitting Diode (LED). Each of the plurality of nodes 200-1 to 200-30 emits light according to an instruction from the terminal 100, for example. In this first embodiment, the nodes 200-1 to 200-30 on a path through which a radio signal is transmitted (which may be hereinafter referred to as a “radio path”) may emit light according to the instruction from the terminal 100. An example of FIG. 1 represents an example in which respective node 200-4, 200-10, 200-15, 200-14, and 200-13 on the radio path emit light in this order.

Furthermore, if a user takes up, inclines, or shakes each of the nodes 200-1 to 200-30, each of the nodes 200-1 to 200-30 may emit light by itself depending on status of the operation. FIG. 1 illustrates an example in which light is emitted as the node 200-4 is inclined.

In addition, at least one of the plurality of nodes 200-1 to 200-30 operates as a gateway capable of communicating with the terminal 100. Such a node may be referred to a node [GW (Gate Way)] in the following. In the example of FIG. 1, a node [GW] is the node 200-13. The node [GW] 200-13 unicast transmits or broadcasts a frame received from the terminal 100 to other node 200. In addition, the node [GW] 200-13 unicast transmits a frame received from the other node 200 to the terminal 100.

The example of FIG. 1 illustrates an example in which the plurality of nodes 200-1 to 200-30 are placed on a floor or the like so that they are shaped like a rectangle as a whole, while being arranged at equal intervals from each other. Each of the nodes 200-1 to 200-30 may be arbitrarily placed as far as they may wirelessly communicate with adjacent nodes 200-1 to 200-30. For example, the plurality of nodes 200-1 to 200-30 may be placed circularly as a whole or may be placed linearly.

Furthermore, each of the nodes 200-1 to 200-30 may be referred to as the node 200 in the following, unless otherwise stated.

<Configuration Examples of Node Apparatus and Terminal Apparatus>

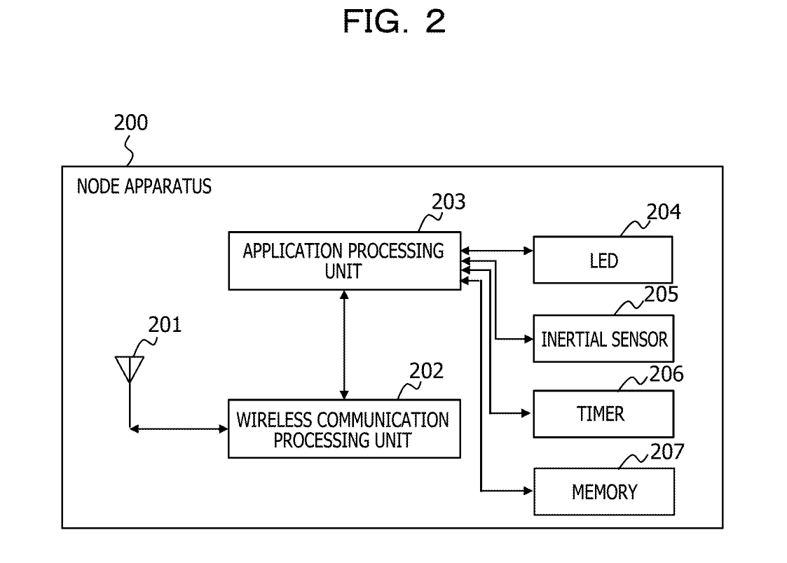

FIG. 2 represents a configuration example of a node 200 and a configuration example of a terminal 100, respectively.

The node 200 includes an antenna 201, a wireless communication processing unit 202, an application processing unit 203, a LED 204, an inertial sensor 205, a timer 206, and a memory 207.

The antenna 201 receives a radio signal that is transmitted from the terminal 100 or other node 200 and outputs the received radio signal to the wireless communication processing unit 202. The antenna 201 also transmits to the terminal 100 or the other node 200 a radio signal that is outputted from the wireless communication processing unit 202.

The wireless communication processing unit 202 performs frequency conversion processing or demodulation processing on the radio signal received from the antenna 201 and extracts a frame. The wireless communication processing unit 202 outputs the extracted frame (or each piece of information or data included in the frame) to the application processing unit 203. The wireless communication processing unit 202 also receives a frame (or each piece of information or data included in the frame) from the application processing unit 203 and converts the received frame into a radio signal in a wireless band by performing modulation processing or the frequency conversion processing on the received frame. The wireless communication processing unit 202 outputs the converted radio signal to the antenna 201.

The application processing unit 203 receives a frame from the wireless communication processing unit 202 and causes the LED 204 to emit light based on each information included in the frame. The application processing unit 203 also receives a frame from the wireless communication processing unit 202 and stores in a memory 207 each information included in the frame. Furthermore, the application processing unit 203 generates a frame by changing a source or a destination of the received frame according to path information stored in the memory 207, and outputs the generated frame to the wireless communication processing unit 202. The frame is transmitted to the other node 200. Details of processing in the application processing unit 203 are described in an operation example.

The LED 204 receives from the application processing unit 203 a gray scale value (or a RGB value. This may be hereinafter referred to as a “RGB” value) and an instruction to emit light, and, based on the instruction, emits light in a color corresponding to the received RGB value.

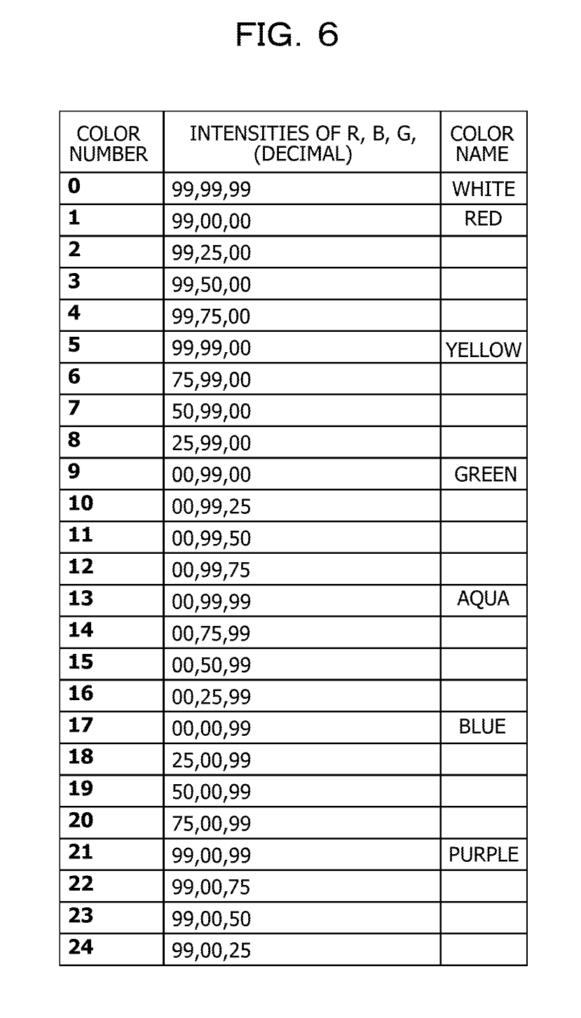

FIG. 6 is a diagram illustrating color numbers, RGB values, and an example of relationship with colors. For example, when the color number is “0”, it represents a “white color”, which is denoted in decimals (99, 99, 99) as the RGB value. The terminal 100 or each of the nodes 200 managing an illumination color of the LED 204 using the color number and providing an instruction on the color number, the LED 204 of each of the nodes 200 emits light corresponding to the color number. The relationship illustrated in FIG. 6 is stored as a table in the memory 207.

With reference back to FIG. 2, the inertial sensor 205 is an acceleration sensor or geomagnetic sensor 205 or the like, for example. In this first embodiment, an acceleration sensor is used as the inertial sensor 205. The inertial sensor 205 may be hereinafter referred to as the acceleration sensor 205. Based on a numerical value measured by the acceleration sensor 205, the application processing unit 203 may detect whether or not the node 200 is off a placement surface, a direction in which the node 200 is inclined, a direction in which the node 200 is shaken, and whether or not there is standstill, or the like.

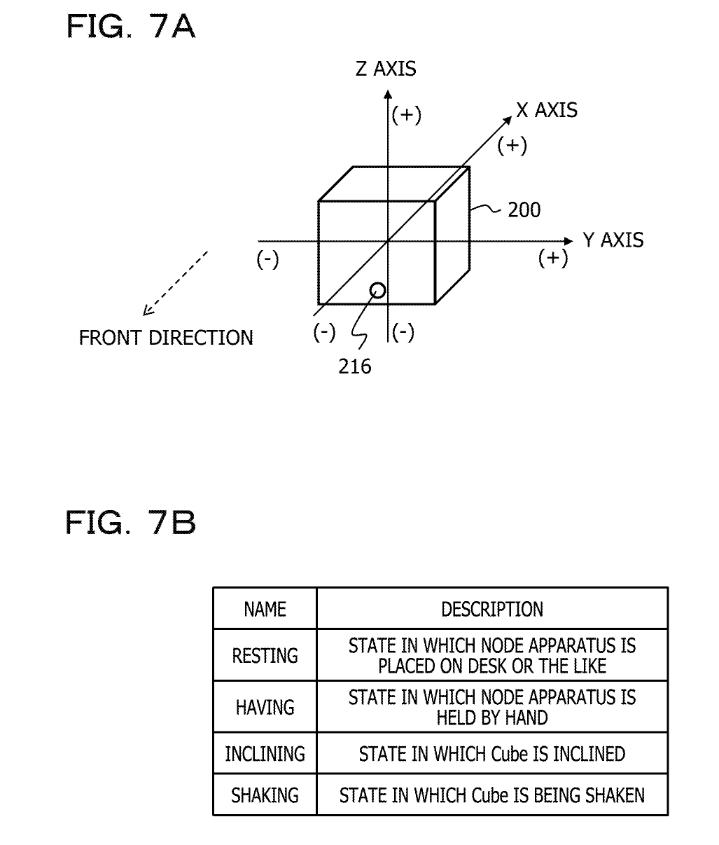

FIG. 7A is a diagram illustrating an example of a direction detected by the acceleration sensor 205. For example, the node 200 includes a battery indicator 216. A direction that the battery indicator 216 faces shall be a front direction, a direction that is on a horizontal plane and parallel to the front direction shall be an X-axis, a direction that is on the horizontal plane and perpendicular to the X-axis shall be a Y-axis, and a direction that is parallel to a plane which is perpendicular to the horizontal plane shall be a Z-axis. For example, it is possible to make a placement surface on which the node 200 is placed the horizontal plane. The acceleration sensor 205 may acquire numerical values from −512 to +512, for example, from each axis of the X-axis, the Y-axis, and the Z-axis. As illustrated in FIG. 7A, if the node 200 is placed on the placement surface, the acceleration sensor 205 may acquire numerical values of (X-axis, Y-axis, Z-axis)=(0, 0, −512) or the like.

FIG. 7B is a diagram illustrating an operation detectable by the acceleration sensor 205. With numerical values of respective axes detected by the acceleration sensor 205 and a count value counted by the timer 206, the application processing unit 203 may detect that the node 200 is in each state of a “resting” state, a “having” state, a “inclining” state, or a “shaking” state.

For example, when obtaining a detection result from the acceleration sensor 205 and the timer 206 that a change of any axis is ±10 for 500 ms, the application processing unit 203 may detect that the node 200 is in the “resting” state.

In addition, for example, when obtaining a detection result from the acceleration sensor 205 and the timer 206 that a change of an Y-axis is equal to or larger than ±10 for three times in 500 ms, the application processing unit 203 may detect that the node 200 is in the “having” state. The “having” state is a state in which the node 200 is off the placement surface, for example.

Furthermore, for example, when obtaining a detection result from the acceleration sensor 205 and the timer 206 that a change of the X-axis or the Y-axis is equal to or larger than ±200 for consecutive 500 ms, the application processing unit 203 may detect that the node 200 is in the “inclining” (or “inclination”) state. In this case, the application processing unit 203 may read a direction in which the node 200 is inclined, for example, from numerical values of the X-axis direction or the Y-axis direction detected by the acceleration sensor 205.

Furthermore, for example, when obtaining a detection result from the acceleration sensor 205 and the timer 206 that a change of any axis is ±300 for three times in 500 ms, the application processing unit 203 may detect that the node 200 is in the “shaking” state.

These numerical values are an example, and the application processing unit 203 may detect each state of the node 200 using numerical values obtained by the acceleration sensor 205.

As such, the acceleration sensor 205 may detect acceleration of the node 200 in the X-axis, the Y-axis, and the Z-axis, for example, and outputs the detected numerical values to the application processing unit 203.

With reference back to FIG. 2, the timer 206 counts time, for example, and appropriately outputs the counted time to the application processing unit 203. Alternatively, when receiving an instruction from the application processing unit 203, for example, the timer 206 starts counting time according to the instruction and appropriately outputs the counted numerical value to the application processing unit 203.

The memory 207 stores, for example, a relationship of the color number and the RGB value (FIG. 6, for example) or path information, or the like. The memory 207 may be appropriately readable or writable by the application processing unit 203.

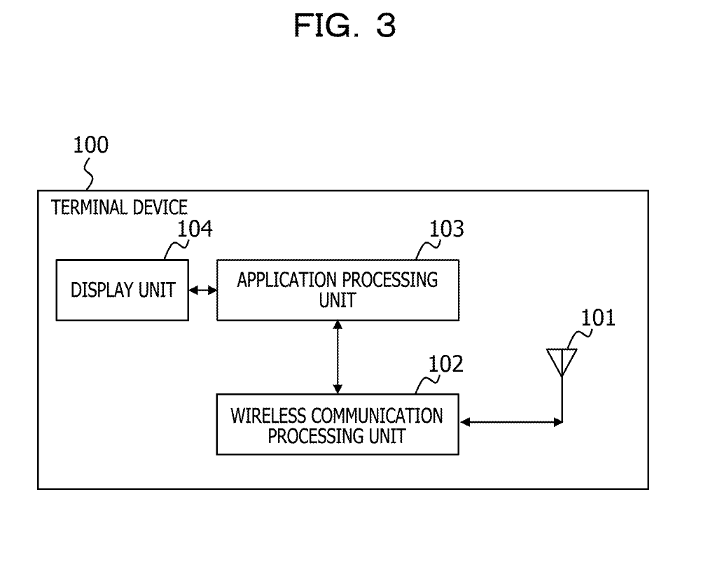

As illustrated in FIG. 3, the terminal 100 includes an antenna 101, a wireless communication processing unit 102, an application processing unit 103, and a display unit 104.

The antenna 101 receives a radio signal transmitted from the node 200 and outputs the received radio signal to the wireless communication processing unit 102. In addition, the antenna 101 receives the radio signal outputted from the wireless communication processing unit 102 and transmits the received radio signal to the node 200.

The wireless communication processing unit 102 extracts a frame transmitted from the node 200 by performing frequency the conversion processing or the demodulation processing on the radio signal received from the antenna 101. The wireless communication processing unit 102 outputs the extracted frame (or information or data included in the frame) to the application processing unit 103. The wireless communication processing unit 102 also receives a frame (or information or data included in the frame) from the application processing unit 103 and converts the received frame into a radio signal in a radio band by performing the modulation processing or the frequency conversion processing on the received frame. The wireless communication processing unit 102 transmits the converted radio signal to the node 200.

The application processing unit 103 generates various frames, for example, and outputs the generated frames to the wireless communication processing unit 102. Examples of such frames include a demo-pattern set request frame or a lighting instruction frame, or the like. By generating such a frame and transmitting to the node 200, the application processing unit 103 may cause the node 200 to emit light in various demo-patterns or cause the node 200 to emit light on a radio path. The application processing unit 103 may also receive from the wireless communication processing unit 102 a frame transmitted from the node 200 and extract various information from the received frame. A frame type and details of the frame type are described below.

The display unit 104 receives an instruction from the application processing unit 103, for example, and indicates in what color the node 200 emits light or the like, according to the instruction.

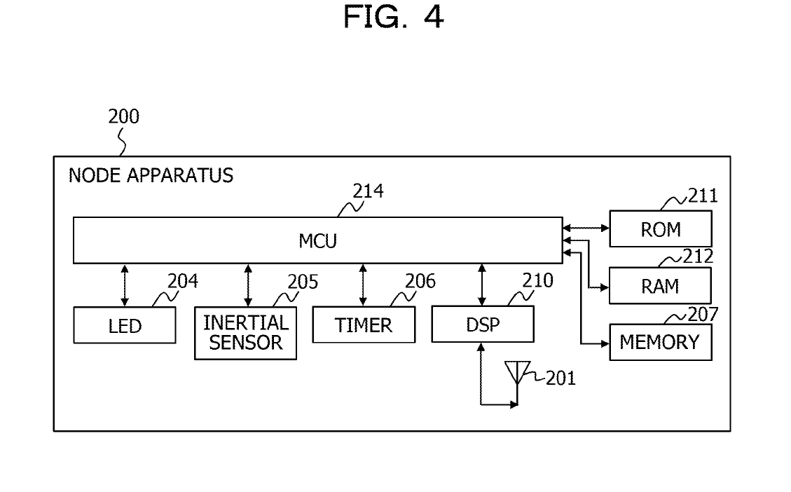

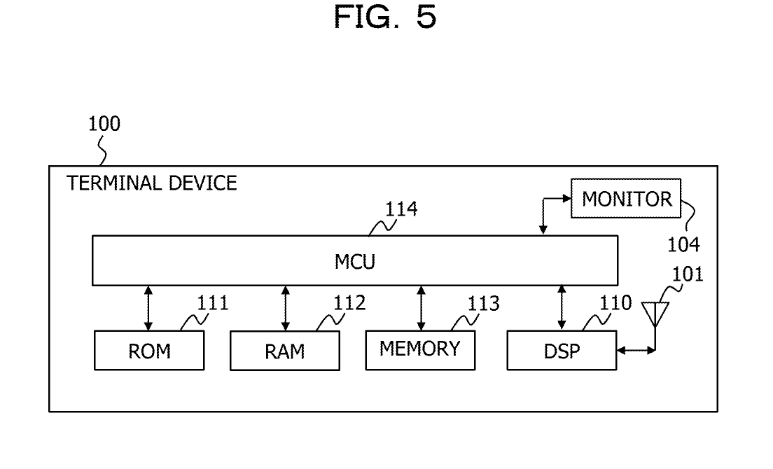

FIG. 4 is a diagram illustrating a hardware configuration example of the node 200 and FIG. 5 is a diagram illustrating a hardware configuration example of the terminal 100, respectively.

The node 200 further includes a digital signal processing unit (DSP) 210, a read only memory (ROM) 211, a random access memory (RAM) 212, and a micro control unit (MCU) 214.

The MCU 214 may implement functions of the application processing unit 203 by reading a program stored in the ROM 211, loading the program to the RAM 212, and executing the loaded program. The MCU 214 corresponds to the application processing unit 203, for example. The DSP 210 then corresponds to the wireless communication processing unit 202, for example.

The terminal 100 further includes a DSP 100, a ROM 111, a RAM 112, a memory 113, and a MCU 114.

The MCU 114 may implement functions of the application processing unit 103 by reading a program stored in the ROM 111, loading the program to the RAM 112, and executing the loaded program. The MCU 114 corresponds to the application processing unit 103, for example. The DSP 110 corresponds to the wireless communication processing unit 102, for example. Furthermore, the monitor 104 corresponds to the display unit 104, for example.

In addition, a processor or a controller such as a central processing unit (CPU), a micro processing unit (MPU), a field programmable gate array (FPGA) may replace the MCU 214, 114.

<Communication Protocol>

In the first embodiment, a protocol for ad-hoc communications is used as a communication protocol.

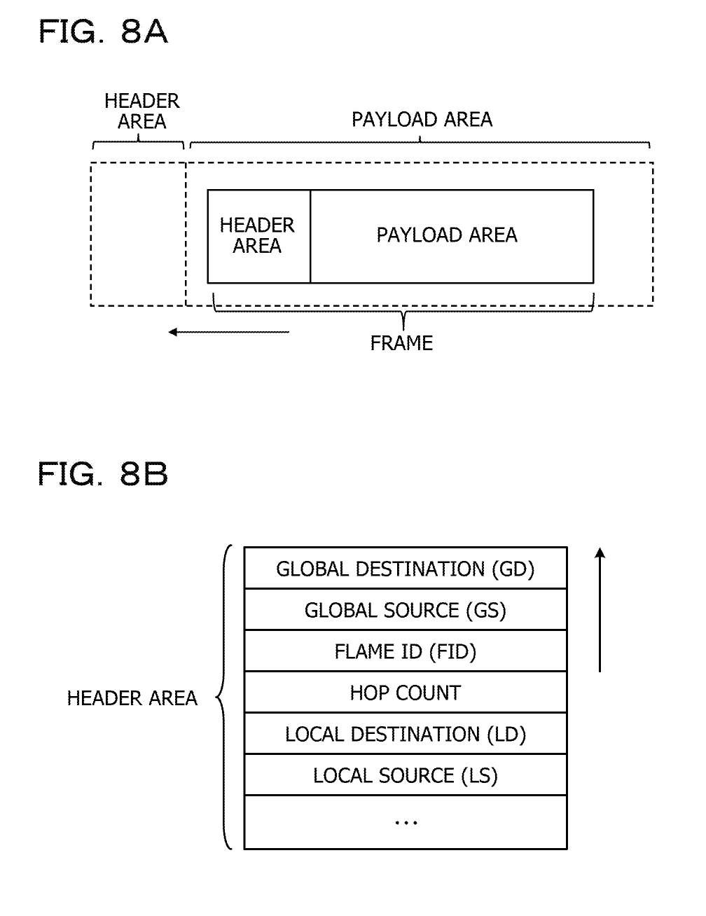

FIG. 8A is a diagram illustrating a frame configuration example with the protocol for ad-hoc communications, and FIG. 8B is a diagram illustrating a configuration example of a header area of the frame thereof, respectively.

As depicted by a solid line in FIG. 8A, the frame according to the protocol for ad-hoc communication includes a header area and a payload area. The protocol for ad-hoc communications corresponds to a network layer (or a third layer) in a reference model of open system interconnection (OSI), for example. The frame according to the protocol for ad-hoc communications may be hereinafter simply referred to as “frame”, for example.

As depicted by a dot-line in FIG. 8A, the frame is further included in the payload area of a lower layer. Such a lower layer (for example, a data link layer, which is a second layer) includes IEEE 802.11 series, for example. In the first embodiment, Bluetooth Low Energy (BLE) is used as a communication protocol for the lower layer like this. The BLE is a near field communication technology, for example, and established as specifications named as Bluetooth® 4.0.

Specifically, an advertising packet of BLE is used. The advertising packet is a packet to be transmitted when a communication apparatus establishes BLE communications or provides a notice. For example, the terminal 100 or the node 200 on a transmitting end generates an advertising packet that includes a frame, and cyclically broadcasts the generated advertising packet for a certain period of time. On the other hand, the terminal 100 or the node 200 on a receiving end may receive the broadcasted advertising packet by searching a predetermined frequency band for a period of time. The terminal 100 or the node 200 on the receiving end may receive a frame by extracting the frame from the received advertising packet. Such processing is performed by a wireless communication processing units 102, 202, for example.

As illustrated in FIG. 8B, the header area of the frame includes a “Global Destination” (which may be hereinafter referred to as a “GD”) and a “Global Source” (which may be hereinafter referred to as a “GS”). The header area also includes a Frame ID (Identification) (which may be hereinafter referred to as a “FID”) and a “hop count”. Furthermore, the header area includes a Local destination (which may be hereinafter referred to as an “LD”) and a Local Source (which may be hereinafter referred to as an “LS”).

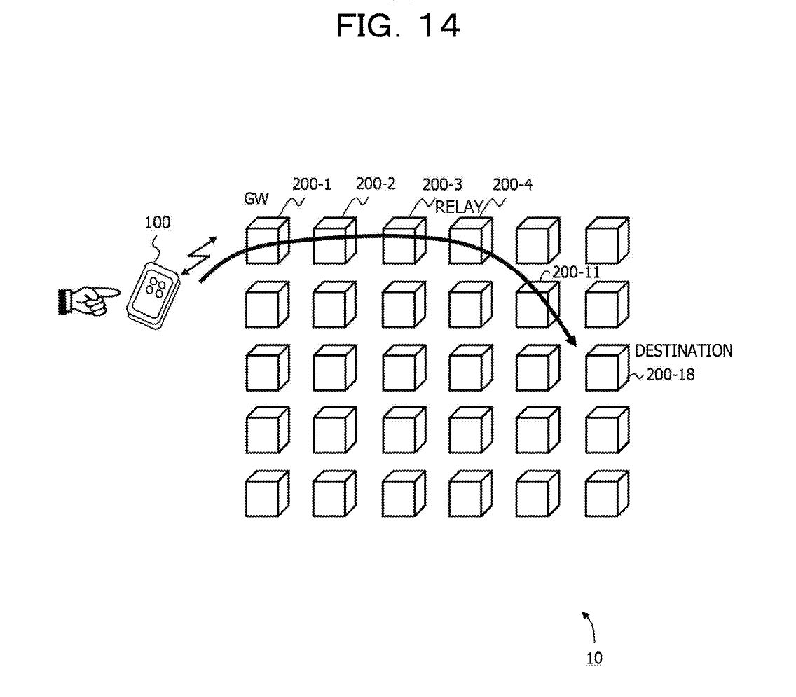

The “GD” is an area where an address of a node 200 that is a final destination of a frame is inserted. In addition, “GS” is an area where a source address in a node of the frame is inserted. For example, in FIG. 14, when a frame is transmitted from the terminal 100 to a destination node 200-18, an address of the destination node 200-18 is inserted into “GD” and an address of the node [GW] 200-1 is inserted into “GS”, respectively. Details are described below.

“FID” represents frame identification information, for example. If the terminal 100 sequentially transmits a plurality of frames, for example, the “FID” which differs for each of the frames is inserted.

The “hop count” represents the number of nodes 200 through which a frame has passed before reaching the destination node 200. The “hop count” may also be referred to as the number of relay times. In FIG. 1, for example, if a frame that the node 200-1 generates and transmits is relayed to the node 200-3, the hop count is “2”. In this case, the node 200-1 transmits the fame with the “hop count” set to “0”. The relay node 200-2 increments the “hop count” to rewrite the “hop count” to “1”. Then, the destination node 200-3 increments the “hop count” to “2”. A number that is counted by the “hop count” may or may not include the source node 200-1, and may or may not include the destination node 200-3, for example.

The “LD” is an area where an address of the node 200 in a next hop, for example, is inserted. The “LS” is an area where an address of the node 200 in a previous hop, for example, is inserted. In FIG. 1, for example, if the node 200-2 receives a frame transmitted from the node 200-1, an address of the own node 200-2 is inserted in the “LD” of the frame, and an address of the node 200-1 is inserted in “LS”, respectively. In addition, if the node 200-2 transmits a frame to the node 200-3, an address of the node 200-3 is inserted in the “LD” of the frame and an address of the own node 200-2 is inserted in the “LS”, respectively.

An “LD” and an “LS” may be determined in each of the nodes 200 based on path information, for example. For example, when receiving a frame into which the address of the own node 200-2 is inserted as the “LD” and the address of the node 200-1 as the “LS”, the node 200-2 performs processing below. More specifically, the node 200-2 starts processing with the address inserted into the “LD”, as the frame addressed to the own node 200-2. When the address inserted in the “LS” is not the address of the own node 200-2, the node 200-2 terminates (or discards) the received frame. Then, the node 200-2 searches the path information in which the previous hop is the node 200-1 and the next hop is the own node 200-2. Then, if the node 200-2 finds such path information, the node 200-2 further recognizes the node 200-3 for the next hop from the path information. For the received frame, the node 200-2 rewrites the “LS” with the address of the own node and the “LD” with the address of the node 200-3. Then, since the “GS” includes the node [GW] 200-1 and the “GD” includes the destination node 200, the node 200-2 may find corresponding path information referring to this. Thus, while rewriting an “LD” and an “LS” according to path information, each of the nodes 200 may unicast transmit a rewritten frame to a node for a next hop.

Furthermore, a frame to be used in the first embodiment is not limited to the network layer, and some of the header area may be a network layer or a higher layer such as an application layer. Also in a lower layer, the frame is not limited to the BLE, and may be such a communication protocol as the IEEE 802.11 series or the like.

<Example of Frame Relay>

In the following, an example of frame relay, in particular, handling of a “GD” or a “GS” is described. Together, it is also described what a role the node [GW] 200 plays.

Here, a description is provided in an example in which a frame generated by the terminal 100 is transmitted to the node 200-6 by way of each of the respective nodes 200-1 to 200-5. As described above, the terminal 100 and the respective nodes 200-1 to 200-6 establish a path in an autonomous-distributed manner with a publicly known method, and retains path information in the memories 113, 207.

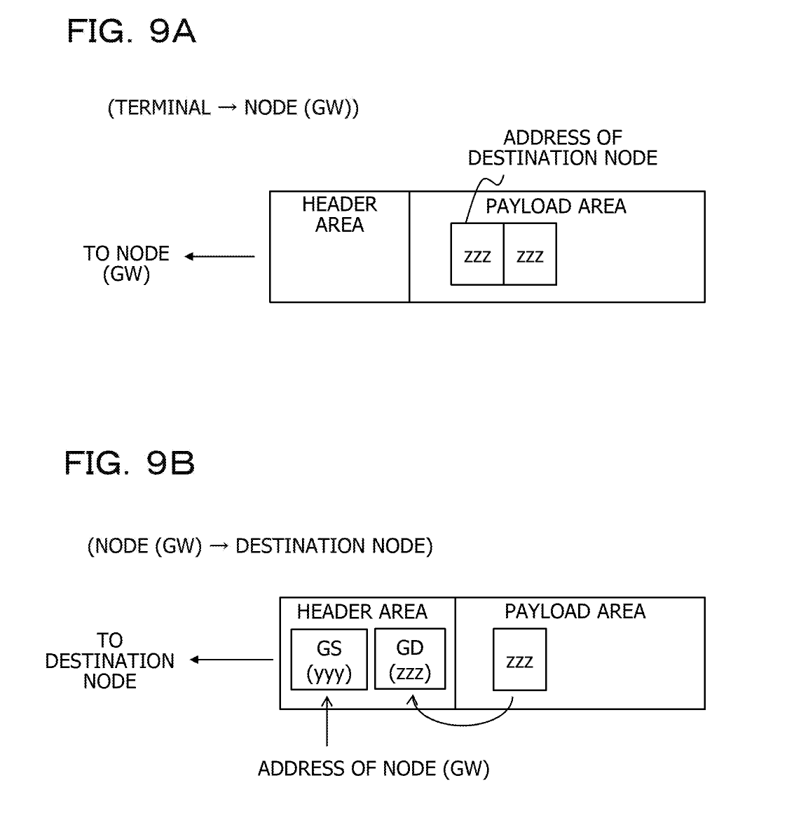

FIG. 9A represents an example of a frame to be transmitted from the terminal 100 to the node [GW] 200-1, and FIG. 9B represents an example of a frame to be transmitted from the node [GW] 20-1 to the destination node 200-6, respectively.

In communications between the terminal 100 and the node [GW] 200-1, a [GD] area and a [GS] area are not used in the header area of the frame. For example, the node 200-1 may add or remove the [GD] area and the [GS] area to or from the header area.

As illustrated in FIG. 9A, the terminal 100 generates a frame including an address of the destination node 200-6 in the payload area. In this frame, the address of the node [GW] 200-1 is inserted in the header area and the address of the terminal 100 in the [LS] area.

The node [GW] 200-1 that received this frame generates a frame having the [GD] area and the [GS] area added to the header area. As illustrated in FIG. 9B, the node [GW] 200-1 inserts the address of the destination node 200-6 in the [GD] area, the address being inserted in the payload area, and inserts the address of the own node [GW] 200-1 in the [GS] area. In addition, the node [GW] 200-1 searches path information that reaches the destination node 200-6 by way of the own node [GW] 200-1, for example, and confirms the address of the node 200-2, which is a next hop destination of the own node [GW] 200-1, in the corresponding path information. The node [GW] 200-1 inserts the address of the node 200-1 in the [LD] area and the address of the own node [GW] 200-1 in the [LS] area. The node [GW] 200-1 thus generates a frame having the addresses inserted in the respective areas, and transmits the frame to the node 200-1 for the next hop, according to the path information.

As described above, while rewriting the [LS] area and the [LD] area according to the path information, each of the relay nodes 200-2 to 200-5 that relay a frame transmits the frame. However, each of the relay nodes 200-2 to 200-5 transmits the frame without rewriting the [GS] area and the [GD] area of the frame. The frame is transmitted with the [GS] area and the [GD] area thereof in a frame state as illustrated in FIG. 9B, for example.

When confirming from the [GD] area, for example, that the own node 200-6 is a destination, the destination node 200-6 terminates (or discards) the received frame.

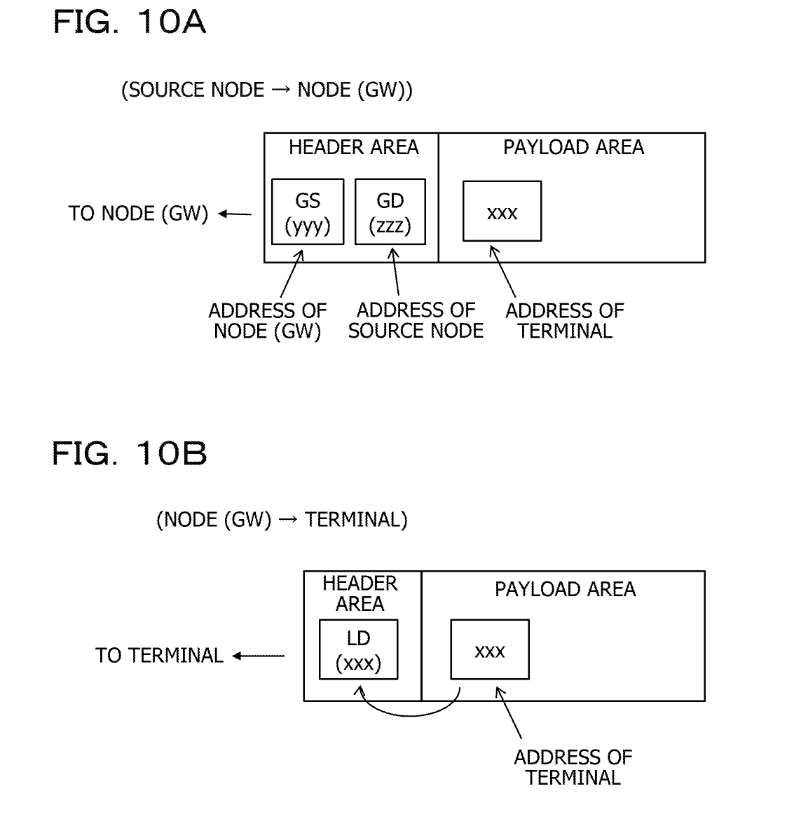

FIG. 10A and FIG. 10B represent an example in which a frame is transmitted in a reverse direction. More specifically, FIG. 10A and FIG. 10B represent an example in which the frame is transmitted from the node 200-6 to the terminal 100 by way of the node [GW] 200-1.

FIG. 10A represents an example of a frame to be transmitted from the node 200-6 to the node 200-5 and FIG. 10B represents an example of a frame to be transmitted from the node [GW] 200-1 to the terminal 100, respectively.

As illustrated in FIG. 10A, the source node 200-6 inserts the address of the terminal 100, which is a destination of a final frame, in the payload area. The node 200-6 also inserts the address of the node [GW] 200-1 in the [GW] area and the address of the own node 200-6 in the [GS] area. Furthermore, the node 200-6 inserts the address of the node 200-5 for a next hop in the [LD] area and the address of the own node 200-6 in the [LS] area, according to the path information.

Each of the relay nodes 200-2 to 200-5 relaying the frame relays the frame while rewriting the [LD] area and the [LS] area according to the path information, as described above.

As illustrated in FIG. 10B, the node [GW] 200-1 deletes the [GS] area and the [GD] area from the frame. Then, the node [GW] 200-1 inserts in the [LD] area the address of the terminal 100 included in the payload area. The node [GW] 200-1 also inserts the address of the own node [GW] 200-1 in the [LS] area. Then, the node [GW] 200-1 transmits to the terminal 100 the frame that is thus deleted or rewritten.

The node [GW] 200-1 functions as a gateway in a node group. Thus, the node [GW] 200-1 includes a [GS] area and a [GD] area which are valid in the node 200 in the frame received from the terminal 100 and transmits the frame to the node 200. The node [GW] 200-1 also deletes the [GS] area and the [GD] area from a frame received from other node 200 and transmits the frame to the terminal 100.

In the following, an example of operation is described on the premise of such frame relay examples.

<Examples of Operation>

In the following, examples of operation are described. The examples of operations are described in the following order:

<1. Demo-pattern>

<1.1 Types of Demo-patterns>

<1.2 Demo-pattern Set Request Frame>

<1.3 Example of Transfer of Demo-pattern Set Request Frame>

<2. Path-demo>

<2.1 Example of Path-demo>

<2.2 Lighting Instruction Frame>

<2.3 Example of Transfer of Lighting Instruction Frame>

<2.4 Reception Processing of Lighting Instruction Frame>

<2.5 Example of Operation on Node apparatus during Path-demo>

<2.5.1 Example of Operation>

<2.5.2 State Notice Frame>

<2.5.3 Example of Transfer of State Notice frame>

<2.5.4 Light Emission Processing>

<2.5.5 State Notice Frame Reception Processing>

<3. Mesh-demo>

<3.1 Example of Mesh-demo>

<3.2 Mesh-demo Execution Frame>

<3.3 Example of Transfer of Mesh-demo Frame>

<3.4 Light Emission Processing>

<3.5 Mesh-demo Execution Frame Reception Process>

<4.1 1hop-demo>

<4.1 Example of 1hop-demo>

<4.2 1hop-demo Execution Frame>

<4.3 Example of Transfer of 1hop-demo Execution Frame>

<4.4 Light Emission Processing>

<4.5 1hop-demo Execution Frame Reception Process>

<5. Restart Frame>

<1. Demo-pattern>

<1.1 Types of Demo-patterns>

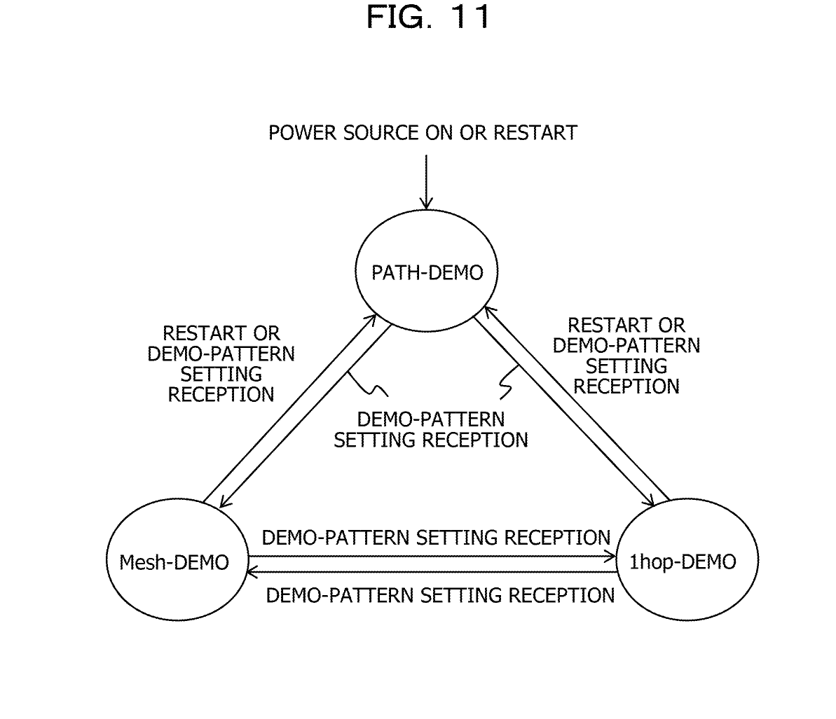

FIG. 11 is a diagram illustrating an example of a state (or mode) transition of a demonstration pattern (which may be hereinafter referred to as a “demo-pattern”). The demo-pattern has three modes of a path demo-pattern (which may be hereinafter referred to as a “path-demo”), a Mesh-demo-pattern (which may be hereinafter referred to as a “Mesh-demo”), and a 1hop demo-pattern (which may be hereinafter referred to as a “1hop-demo”).

The path-demo is a mode configured to visualize a radio path by, for example, a node 200 on the radio path emitting light. Details of the path-demo are described in <2. Path-demo>.

The Mesh-demo is a mode in which, for example, when a user takes up and shakes a node 200, the node 200 emits light, and when the user places the node 200, then a group of other nodes 200 emits light so that the light spreads radially.

Furthermore, the 1hop-demo is a mode in which, for example, when the user takes up and shakes a node 200, the node 200 emits light, and when the user places the node 200, then a group of other nodes 200 emits so that the light spreads like a curtain call or a ripple.

As illustrated in FIG. 11, a transition to each state is as follows. More specifically, when power of the node 200 turns on or the node 200 restarts, the node 200 enters a path-demo state. Then, when the terminal 100 transmits a frame called a demo-pattern set frame and the node 200 receives this frame, the node 200 transfers to a Mesh-demo or 1hop-demo state instructed by the demo-pattern set frame. The demo-pattern set frame is a frame to cause the node 200, for example, to perform a demo-pattern.

As illustrated in FIG. 11, when the node 200 in the Mesh-demo state receives the demo-pattern set frame transmitted from the terminal 100, the node 200 transfers to the path-demo or 1hop-demo state instructed by the demo-pattern set frame. In addition, when the node 200 in the 1hop-demo state receives the demo-pattern set frame transmitted from the terminal 100, the node 200 transfers to the Mesh-demo or the path-demo instructed by the demo-pattern set frame. When the node 200, which is in the Mesh-demo or 1hop-demo state, restarts, the node 200 transfers to the path-demo.

<1.2 Demo-Pattern Set Request Frame>

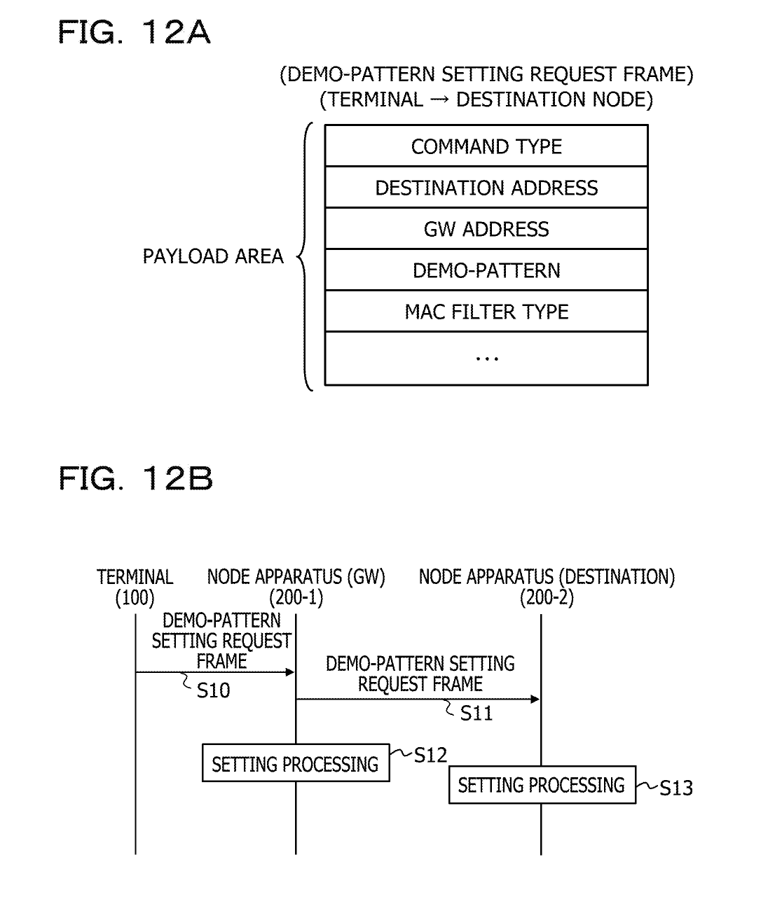

A demo-pattern set request frame is described hereinafter. FIG. 12A is a diagram illustrating a configuration example of the demo-pattern set request frame. Furthermore, a header area of the demo-pattern set request frame is the configuration example illustrated in FIG. 8B, for example. For other types of frames, a configuration of a header area is the example illustrated in FIG. 8B, for example.

The demo-pattern set request frame includes a “command type”, a “destination address”, a “GW address”, a “demo-pattern”, and a “MAC filter type” in a payload area of the demo-pattern set request frame.

The “command type” is an area where command type information is inserted, the command type information identifying to other types of frames that a frame is a demo-pattern set request frame. In addition, the “destination address” is an area where an address of a final destination of a demo-pattern set request frame, for example, is inserted. Furthermore, the “GW address” is an area where an address of the node [GW] 200, for example, is inserted. The address of the node [GW] 200 is a predetermined fixed value, for example.

The “demo-pattern” is an area where demo-pattern information representing a demo-pattern is inserted. The demo-pattern information includes information that represents a path-demo, a Mesh-demo, or a 1hop demo. As an example, when the demo pattern information is “0”, the demo-pattern is the path-demo, when “1”, the demo pattern is the Mesh-demo, and when “2”, the demo pattern is the 1hop-demo.

The “MAC filter type” is an area where filter type information that identifies a MAC filter type is inserted. A MAC filter is a function that allows or rejects communications with a certain node 200, for example. The filter type information has three types of “No filter”, “Peripheral 8 nodes”, and “Upper and lower 4 nodes”.

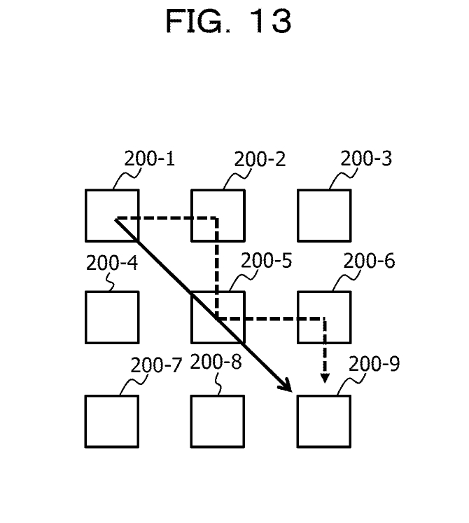

FIG. 13 is a diagram illustrating a frame relay example with the MAC filter pattern. The “No filter” represents a pattern capable of communications with all nodes, for example. In an example of FIG. 13, in the case of the “No filter”, the node 200-1 is of the filter type capable of communications with all other nodes 200-2 to 200-9.

The “Peripheral 8 nodes” is a filter type that may communicate with 8 nodes in up, down, right, and left directions and diagonal directions, centering around the own node, and that may not communicate with any other nodes 200 than the 8 nodes. In the example of FIG. 13, in the case of the “Peripheral 8 nodes”, the node 200-1 may communicate with the node 200-5 in the diagonal direction, and the node 200-5 may communicate with the node 200-9 in the diagonal direction. In this case, the node 200-5 may communicate with the peripheral 8 nodes of 200-1 to 200-4 and 200-6 to 200-9.

The “Upper and lower 4 nodes” is a filter type that allows communications with 4 nodes around the own node 200, the 4 nodes being above and below, and to the right and left of the own node 200, for example, and that does not allow communications with any other nodes 200 than the 4 nodes. In the example of FIG. 13, in the case of the “Upper and lower 4 nodes”, the node 200-1 may not communicate with the node 200-5, and may communicate with the node 200-2 on the right side and the node 200-4 under the node 200-1. In the example of FIG. 13, the node 200-1 is in communication with the node 200-2. In addition, the node 200-5 may not communicate with the node 200-9 in the diagonal direction, either, and may communicate with the nodes 200-2, 200-4, 200-6, and 200-8 which are on the left, right, top, and bottom of the node 200-5. In the example of FIG. 13, the node 200-5 is in communication with the node 200-6.

When the MAC filter is switched between “Peripheral 8 nodes” and “Upper and lower 4 nodes”, for example, the nodes 200 newly build paths in an autonomous distributed manner, newly recreates path information, and transmits a frame based on the newly created path information.

<1.3 Example of Transfer of Demo-Pattern Set Request Frame>

FIG. 12B is a sequence diagram representing an example of transfer of a demo-pattern set request frame. FIG. 12B illustrates an example in which a destination node is the node 200-2.

The terminal 100 generates a demo-pattern set request frame and transmits the frame to the node [GW] 200-1 (S10).

The terminal 100 performs the following processing, for example. More specifically, an application processing unit 103 reads from a memory 207 command type information indicating that a frame is a demo-pattern set request frame, a final destination address of the frame, a GW address, a demo-pattern, a MAC filter type or the like. Then, the application processing unit 103 generates a demo-pattern set request frame that includes the information in a payload area and outputs the frame to the wireless communication processing unit 102. The wireless communication processing unit 102 converts the received demo-pattern set request frame to a radio signal and transmits the converted radio signal.

When receiving the demo-pattern set request frame, the node [GW] 200-1 transmits the demo-pattern set request frame to the destination node 200-2 (511). Then, the node [GW] 200-1 performs set processing (S12). The node [GW] 200-1 performs the following processing, for example.

More specifically, a wireless communication processing unit 202 of the node [GW] 200-1 receives the radio signal transmitted from the terminal 100, extracts the frame from the received radio signal, and outputs the frame to the application processing unit 203. When confirming that an address inserted in the “LD” area in the frame header area is the address of the own node 200-1, the application processing unit 203 confirms the command type information that is inserted into the “command type” from the payload. When the application processing unit 203 determines from the type that the received frame is the demo-pattern set frame, the application processing unit 203 stores in the memory 207 the “demo-pattern”, the “MAC filter type”, or the like that are inserted in the payload area. With this, the “set processing” is performed. Subsequently, the node [GW] 200-1 transmits and receives a frame according to the “demo-pattern” and the “MAC filter type” stored in the memory 207. Then, the application processing unit 203 rewrites the addresses inserted in the “LD” area and the “LS” area of the received frame, according to the path information. The application processing unit 203 outputs the received frame whose “LD” area and “LS” area are rewritten to the wireless communication processing unit 102. The wireless communication processing unit 102 converts the received demo-pattern set request frame into a radio signal and transmits the converted radio signal.

For the destination node 200-2 that receives the demo-pattern set request frame, similar to the node [GW] 200-1, the application processing unit 203 also stores the “demo-pattern” and the “MAC filter type” in the memory 207. With this, subsequently, the node 200-2 also receives data according to the “demo-pattern” and the “MAC filter type”. Since the node 200-2 is the destination node, the application processing unit 203 confirms that the “destination address” inserted into the payload area of the demo-pattern set request frame is the own station, and then terminates the received frame.

Furthermore, each of the nodes 200 that receives the demo-pattern set request frame transmits or receives a frame to be used in a demo-pattern after setting is changed. In this case, each of the nodes 200 disrupts transmission or reception of a frame used in a demo-pattern that is not the demo-pattern after the setting is changed. For example, the following processing is performed.

More specifically, by receiving the demo-pattern set request frame, after setting is changed, the application processing unit 203 determines the frame received from the wireless communication processing unit 202 based on the “command type information” inserted into the payload area. Specifically, if the command type information of the received frame is the command type information that is used in the demo-pattern after the setting is changed, the application processing unit 203 performs reception processing, and if not, the application processing unit 203 only has to terminate (or discard) the received frame. The memory 207 stores the command type information to be used for every demo-pattern. The application processing unit 203 may confirm what frame is used in a demo-pattern after setting is changed, by acquiring the command type information from the memory 207.

A frame to be used in each demo-pattern is described when each demo-pattern is described.

<2. Path-Demo>

<2.1 Example of Path-Demo>

A path-demo is described hereinafter. FIG. 14 is a diagram illustrating an example of a path-demo. When the terminal 100 gives an instruction on a path demo, the nodes 200-1 to 200-4, 200-11, and 200-18, which are located on the radio path, emit light in this order. An LED lighting instruction frame (which may be hereinafter referred to as a “lighting instruction frame”) is transmitted from the terminal 100. The lighting instruction frame is transmitted to a destination node 200-18 by way of the relay nodes 200-1 to 200-4, and 200-11, according to preset path information. More specifically, each of the nodes 200-1 to 200-4 and 200-11 transmits a lighting instruction frame according to path information that is created in an autonomous distributed manner, and the nodes 200-1 to 200-4, 200-11, and 200-18 on the path, through which the lighting instruction frame is transmitted, emit light.

<2.2 Lighting Instruction Frame>

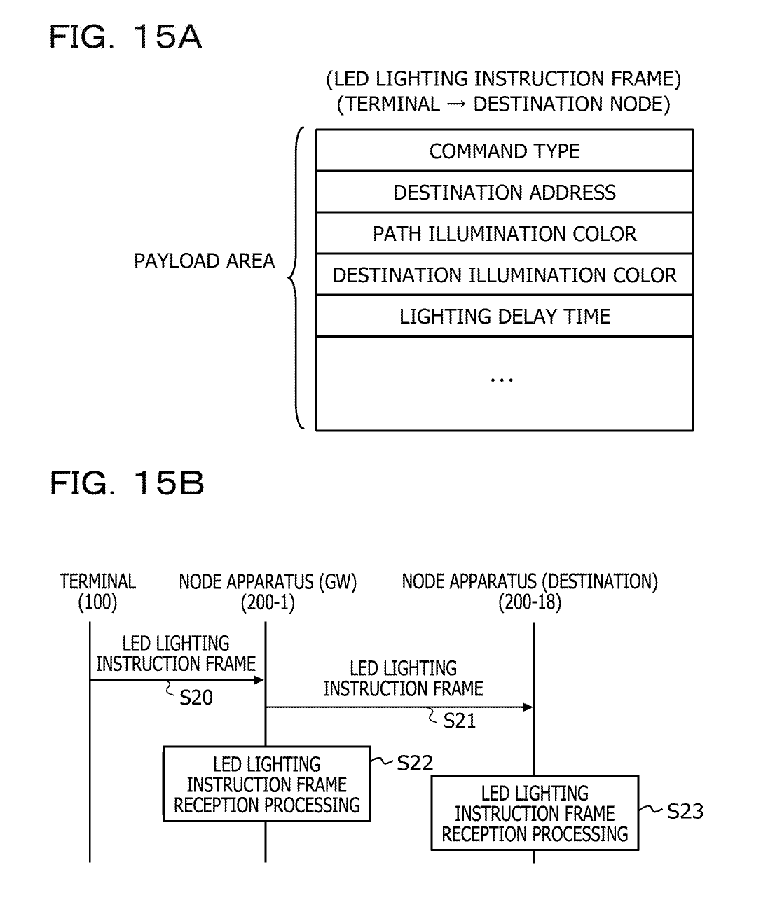

FIG. 15A is a diagram illustrating a configuration example of a lighting instruction frame. The light instruction frame includes a “command type”, a “destination address”, a “path illumination color”, a “destination illumination color”, and a “lighting delay time” in a payload area of the light instruction frame.

The “command type” is an area where command type information is inserted, the command type information identifying to other types of frames that a frame is a lighting instruction frame. The “destination address” is an area where destination address information of the node 200 that is a final destination in the path information for the lighting instruction frame, for example, is inserted. In an example of FIG. 14, the “destination address” is an address of the node 200-18.

The “path illumination color” is an area where path illumination color information is inserted, the path illumination color information representing a color of light emitted by the nodes 200 on the path based on the path information. In the example of FIG. 14, if the nodes 200-1 to 200-4 and 200-11 are caused to emit light in white, a color number “0” (FIG. 6, for example) is inserted in the “path illumination color”.

The “destination illumination color” is an area where destination illumination color information is inserted, the destination illumination color information representing a color of light emitted by the final destination node 200 in the path information. In the example of FIG. 14, if the node 200-18 is caused to emit light in red, the color number “1” (FIG. 6, for example) is inserted in the “destination illumination color”.

The “lighting delay time” is an area where time information is inserted, the time information indicating timing to cause an LED 204 to emit light in the nodes 200 on the path, for example. Each of the nodes 200 that relay the lighting instruction frame lights up the LED 204 based on the time information inserted in the “lighting delay time”. Specifically, each of the nodes 200 causes the LED 204 to emit light after elapse of time that is obtained by multiplying time indicated in the “lighting delay time” (which may be referred to as lighting delay time) by the hop count. In the example of FIG. 14, for example, the node 200-1 lights up the LED 204 after the time obtained by multiplying the lighting delay time by the hop count “1” elapses. The node 200-2 lights up the LED 204 after the time obtained by multiplying the lighting delay time by the hop count “1” elapses. Thus, in this example, among the respective nodes 200 on the path, the node 200-1 lights up earliest, and the node 200-18 lights up latest. This enables the nodes 200-1 to 200-4, 200-11, and 200-18 on the path to light up in the order of relaying the lighting instruction frame, along the path through which the lighting instruction frame is transmitted.

<2.3 Example of Transfer of Lighting Instruction Frame>

FIG. 15B is a sequence diagram illustrating a transfer example of a lighting instruction frame. An example of FIG. 15B illustrates the example of FIG. 14, and the relay nodes 200-2 to 200-4, and 200-11 are omitted.

The terminal 100 generates a lighting instruction frame and transmits the generated lighting instruction frame to the node [GW] 200-1 (S20). The terminal 100 performs the following processing, for example.

More specifically, an application processing unit 103 reads from a memory 113 each of command type information, destination address information, path illumination color information, destination illumination color information, and lighting delay time information that are stored in the memory 113. The application processing unit 103 generates a lighting instruction frame that includes the read information in the payload area. In addition, the application processing unit 103 inserts an address of the node [GW] 200-1 that is read from the memory 113, into an “LD” area of the lighting instruction frame. The application processing unit 103 outputs the generated lighting instruction frame to the wireless communication processing unit 102. The wireless communication processing unit 102 converts the lighting instruction frame into a radio signal and transmits the radio signal.

When receiving the lighting instruction frame transmitted from the terminal 100, the node [GW] 200-1 transmits the lighting instruction frame to the node 200 for a next hop (S21).

Then, the node [GW] 200-1 performs lighting instruction frame reception processing (S22). The lighting instruction frame reception processing is described below.

When receiving the lighting instruction frame, a destination node 200-18 also performs the lighting instruction frame reception processing (S23).

<2.4 Reception Process of Lighting Instruction Frame>

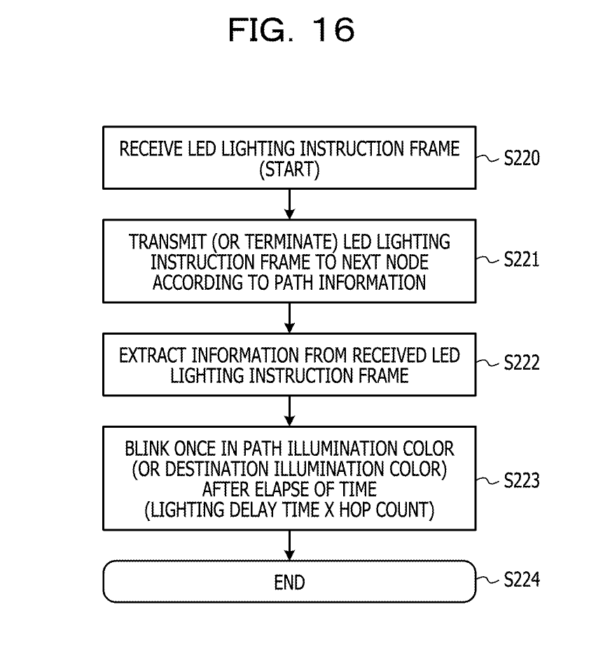

FIG. 16 is a flow chart illustrating an example of a LED lighting instruction frame reception process. For example, processing in the node [GW] 200-1 is described.

When receiving a lighting instruction frame, the node [GW] 200-1 starts the processing (S220).

Then, the node [GW] 200-1 transmits the lighting instruction frame to the node 200, according to path information (S221). The node [GW] 200-1 performs the following processing, for example.

More specifically, when receiving a radio signal transmitted from the terminal 100, the wireless processing unit 202 of the node [GW] 200-1 extracts a frame from the received radio signal and outputs the extracted frame to the application processing unit 203. When confirming that an address inserted into an “LD” area of the frame is the own node [GW] 200-1, the application processing unit 203 determines from command type information inserted into “command type” in the payload area that the received frame is a lighting instruction frame. The application processing unit 203 rewrites addresses inserted in the “LD” area and an “LS” are of the received frame, according to path information stored in the memory 207. The application processing unit 203 also rewrites the “number of hop” (FIG. 8B, for example) in the header area of the lighting instruction frame to a value that is incremented by +1. The application processing unit 203 outputs the written lighting instruction frame to the wireless communication processing unit 202. The wireless communication processing unit 202 converts the received lighting instruction frame into a radio signal and transmits the radio signal.

Then, the node [GW] 200-1 extracts information from the received lighting instruction frame (S222). For example, the application processing unit 203 of the node [GW] 200-1 extracts the “path illumination color” and “effective delay time” from the payload area of the lighting instruction frame and the “hop count” from the header area.

Then, the node [GW] 200-1 causes the LED 204 to blink once in a color indicated by the path illumination color, after (lighting delay time×hop count) time elapses (S223). The node [GW] 200-1 performs the following processing, for example.

More specifically, the application processing unit 203 calculates time obtained by multiplying the “lighting delay time” and the “hop count” that are extracted from the lighting instruction frame. The application processing unit 203 determines whether or not time counted by a timer 206 passes the (“lighting delay time”×“hop count”) time from time when the lighting instruction frame is received from the wireless communication processing unit 202. The application processing unit 203 waits till the counted time passes the (“lighting delay time”×“hop count”) time. Then, when that time elapses, the application processing unit 203 reads from the memory 207 an RGB value that corresponds to a color number of the “path illumination color”. Then, the application processing unit 203 outputs the RGB value read from the memory 207 to the LED 204 and instructs the LED 204 to blink once. Following the instruction, the LED 204 blinks once in a color corresponding to the RGB value. Then, the LED 204 may cause the blinking color to fade out. The fade-out is processing that, for example, the LED 204 emits light so that the RGB value representing the blinking color approaches to (0, 0, 0) as time passes. Alternatively, the LED 204 may cause the blinking color to fade in. The fade-in is processing that, for example, causes the RGB value representing the blinking color to change from (0,0,0) to the color of the instructed RGB value. Furthermore, blinking refers to the LED 204, for example, turning off after emitting light. While one blink ends when the LED 204 turns off, in more than one blink, the LED 204 repeats emitting light again and then turning off.

Then, the node [GW] 200-1 finishes a series of processing (S224).

Although operation of the nodes 200-2 to 200-4 and 200-11 are omitted in the example of FIG. 14, the nodes 200-2 to 200-4 and 200-11 perform similar processing to the node [GW] 200-1 in that when receiving the lighting instruction frame, the nodes 200-2 to 200-4 and 200-11 perform the lighting instruction frame reception processing. Then, each of the nodes 200-2 to 200-4 and 200-11 calculates the time of “lighting delay time”×“hop count” (S223). However, as the “hop count” sequentially moves up, a value of “lighting delay time”×“hop count” sequentially becomes longer. Thus, the larger the number of relays is, the later the blinking start time is, and the relay nodes start blinking in the order of the node 200-1 to 200-4, 200-11, and 200-11.

<2.5 Example of Operation on Node Apparatus During Path-Demo>

In the following, when a user takes up the node 200 from a location of placement and inclines the node 200, an operation target node (which may be hereinafter referred to as an “operating node”) emits light. Then, when the user installs the operating node 200 at the location of placement, each of the nodes including the operating node 200 on the radio path emits light. This operation example is described hereinafter.

<2.5.1 Example of Operation>

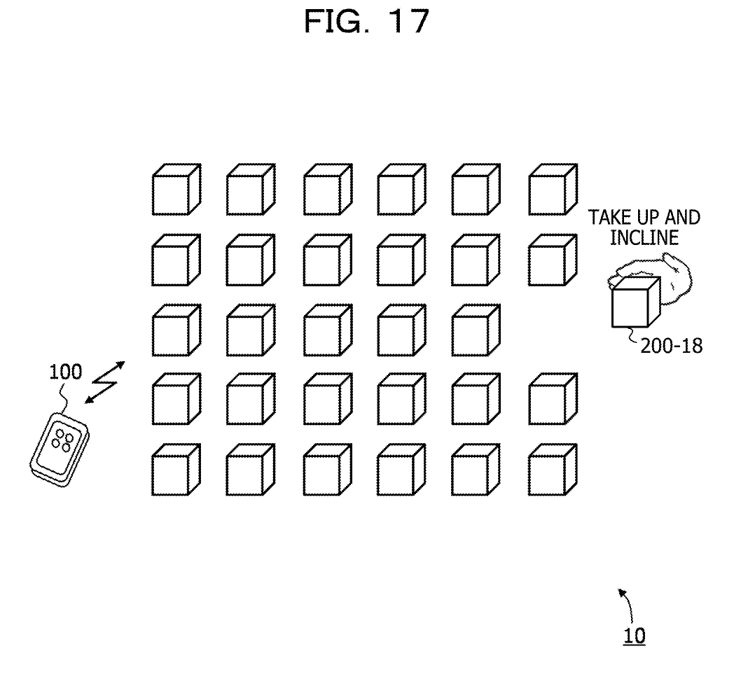

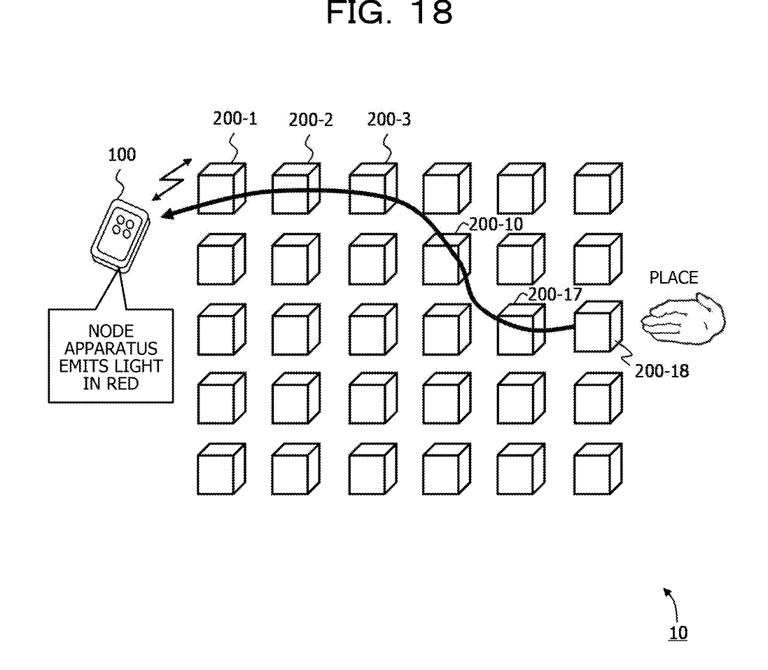

FIG. 17 and FIG. 18 are diagrams illustrating an example of operation. As illustrated in FIG. 17, when the user takes up and inclines the node 200-18 that is placed on a floor or the like, the node 200-18 emits light in a color corresponding to the inclination. Then, as illustrated in FIG. 18, if the user places the node 200-18 on the floor or the like while inclining the node 200-18, each of the node 200-17, 200-10, 200-3 to 200-1 on the radio path sequentially emits light, with the node 200-18 as a starting point. Then, the node 200-18 which is the target of operation generates and transmits a frame called a state notice frame. The state notice frame is relayed through each of the nodes 200-17, 200-10, 200-3 to 200-1 according to preset path information and transmitted to the terminal 100. A display unit 104 of the terminal 100 indicates in what color each of the nodes 200-18, 200-17, 200-10, and 200-3 to 200-1 emits light.

Furthermore, the operating node 200 may be the node [GW] 200-1. In this case, the operating node 200-1 emits light in a color corresponding to a direction in which the operating node 200-1 inclines, and directly transmits the state notice frame to the terminal 100.

<2.5.2 State Notice Frame>

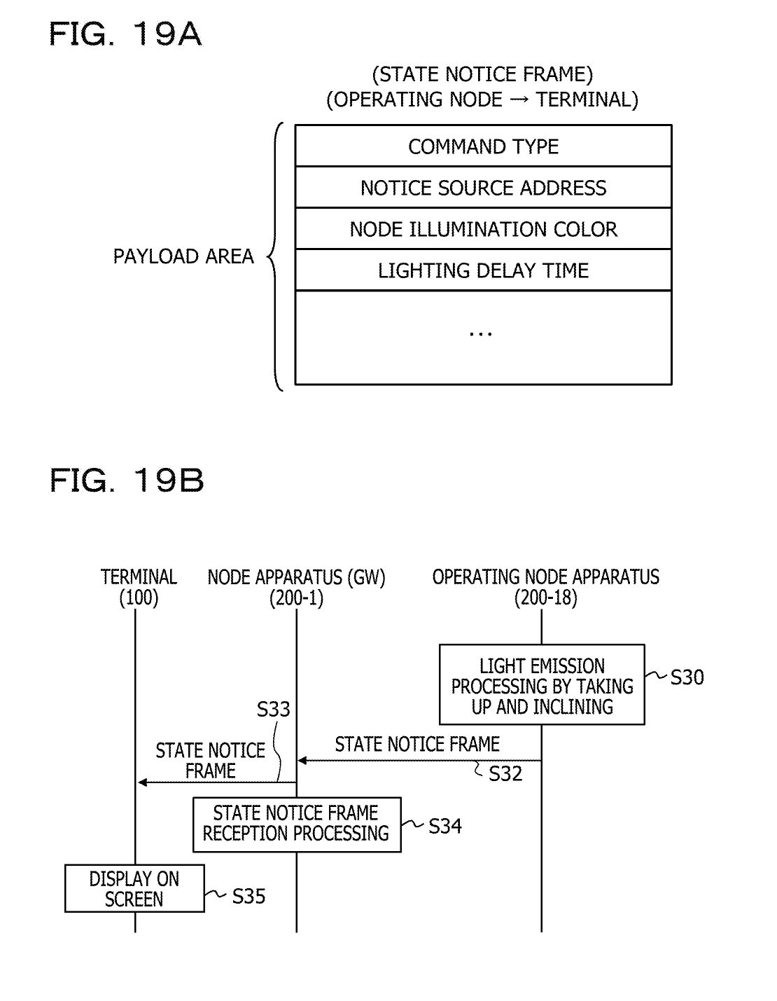

FIG. 19A is a diagram illustrating a configuration example of a state notice frame. The state notice frame includes a “command type”, a “notice source address”, “node illumination color”, and “lighting delay time”.

The “command type” is an area where command type information is inserted, the command type information identifying to other types of frames that a frame is a state notice frame. The notice source address” is an area where the address of the node (or operating node) 200 that is taken up and inclined by the user, for example. In an example of FIG. 17, the address of the operating node 200-18 is inserted in the “notice source address”.

The “node illumination color” is an area where illumination color information is inserted, the illumination color information representing a color in which the operating node 200 has emitted light. In the example of FIG. 17, a color number corresponding to the color of light emitted by the operating node 200-18 is inserted in the “node illumination color”.

The “lighting delay time” is an area, for example, where time information indicating timing to cause the LED 204 to emit light is inserted. The “lighting delay time” is similar to the “lighting delay time” of the lighting instruction frame (FIG. 15A, for example). Each of the nodes 200 on the path emits light after the time of the “lighting delay time”×the “hop count” elapses.

<2.5.3 Example of Transfer of State Notice Frame>

FIG. 19B is a sequence diagram illustrating a transfer example of a state notice frame. In FIG. 19B, with FIG. 17 and FIG. 18 as an example, the operating node is the node 200-18, and relay nodes 200-17, 200-10, 200-3 to 200-2 are omitted.

The operating node 200-18 performs light emission processing (S30) by being taken up and inclined. The light emission processing is described below.

Then, the operating node 200-18 generates and transmits a state notice frame (S32). The operation target node 200-18 performs the following processing, for example.

More specifically, the application processing unit 203 reads from the memory 207 the command type information indicating that the frame is a state notice frame, address information of the own station, and the lighting delay time information from the memory 207. Then, the application processing unit 203 reads from the memory 107 a color number representing a color that causes the LED 204 to emit color, as illumination color information. The application processing unit 203 generates a state notice frame including the information in a payload, and outputs the state notice frame to the wireless communication processing unit 202. The wireless communication processing unit 202 converts the received state notice frame into a radio signal and transmits the signal.

When receiving the state notice frame, the node [GW] 200-1 transmits the state notice frame to the terminal 100. Then, the node [GW] 200-1 performs state notice frame reception processing (S34). Furthermore, the state notice frame reception signal is described below.

When receiving the state notice frame transmitted from the node [GW] 200-1, the terminal 100 displays illumination colors of the nodes 200-18, 200-17, 200-10, and 200-3 to 200-1 on a screen of the display unit 104 (S35). The terminal 100 performs the following process, for example.

More specifically, when receiving the radio signal transmitted from the node GW (200-1), the wireless communication processing unit 102 extracts a frame from the received radio signal and outputs the frame to the application processing unit 103. When confirming that an address inserted in an “LD” area of the received frame is the own terminal 100, the application processing unit 103 determines from command type information inserted in the “command type” in a payload area of the received frame that the frame is a state notice frame. Then, the application processing unit 103 extracts a color number inserted in the “node illumination color” in the payload area and reads a color corresponding to the color number from the memory 113. The application processing unit 103 outputs information on the read color to the display unit 104. The display unit 104 displays information indicating in what color the nodes 200 emit light, based on the received color information.

<2.5.4 Light Emission Processing>

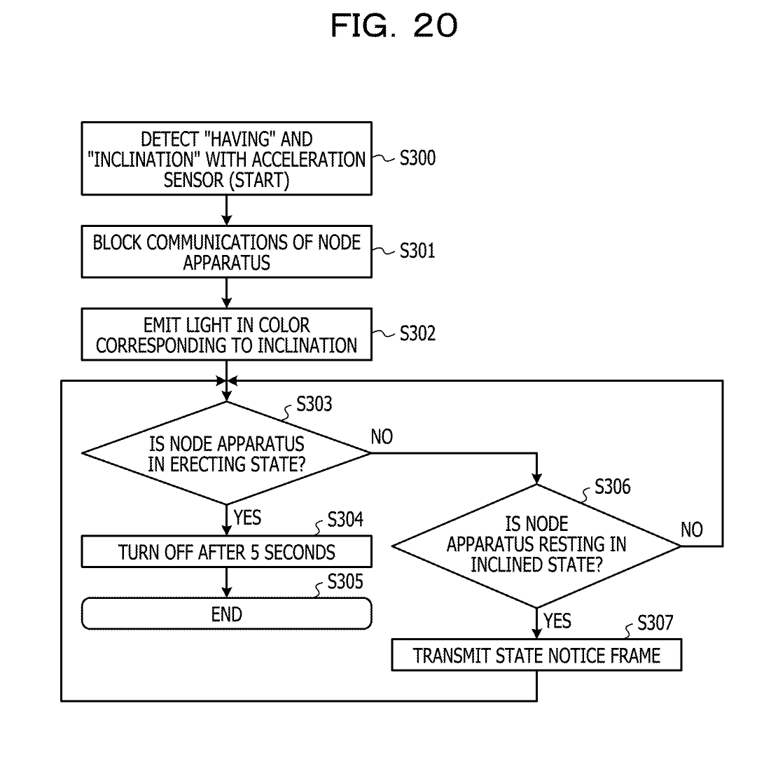

The light emission processing (S30) is described hereinafter. FIG. 20 is a flow chart illustrating an example of light emission processing. The light emission processing is also described with the operating node 200-18 as an example.

The node 200-18 detects “having” and “inclination” of the own node 200-18 with the acceleration sensor 205 (S300). The operating node 200-18 performs the following processing, for example.

More specifically, the application processing unit 203 instructs the acceleration sensor 205 to start detection and the timer 206 to count time. Following the instruction from the application processing unit 203, the acceleration sensor 205 starts detection and acquires respective numerical values in three directions (X-axis, Y-axis, and Z-axis illustrated in FIG. 7A, for example). The acceleration sensor 205 outputs the acquired numerical values to the application processing unit 203. The timer 206 also outputs counted time to the application processing unit 203. Based on the received numerical values and the counted time, the application processing unit 203 detects that the node 200-18 is in a “having” state and a “inclined” state. As described above, when detecting a value of ±10 or larger in any of the axes three times or more in 500 ms, the application processing unit 203 may detect that the own node is in the “having” state, or the like.

Then, the operating node 200-18 blocks communications of the own node 200-18 (S301). For example, when detecting the “having” state, the application processing unit 203 instructs the wireless communication processing unit 202 to block communications. In response to this instruction, even when receiving a radio signal, the wireless communication processing unit 202 blocks communications by discarding the received radio signal or alternatively turning off power of the wireless communication processing unit 202.

Then, the operating node 200-18 causes the LED 204 to emit light in a color corresponding to inclination (S302). The operating node 200-18 performs the following processing, for example.

More specifically, the memory 207 stores a table indicating a color corresponding to a range of the numerical values of the X-axis and the Y-axis which are acquired by the acceleration sensor 205, such as “white” from +200 to +210, “yellow” from +211 to +220, or the like. The application processing unit 203 reads a color corresponding to the received numerical value from the table stored in the memory 207. The application processing unit 203 reads from the memory 207 an RGB value corresponding to the read color. Then, the application processing unit 203 outputs the read RGB value to the LED 204, and instructs the LED 204 to emit light. In response to this instruction, the LED 204 emits light in a color corresponding to the received RGB value.

Then, the operating node 200-18 detects whether or not the operating node 200-18 is in an erecting state (S303). This processing is configured to detect in what state the operating node 200-18 is placed, if the operating node 200-18 is placed on a floor or the like after being taken up and inclined. Here, the erecting state refers to a state in which when the operating node 200-18 is placed on the floor or the like after being taken up and inclined, the operating node 200-18 is placed in a same direction and at a same inclination as the direction and the inclination before the operating node 200-18 is taken up. For example, if the application processing unit 203 detects a “resting state” based on a numerical value from the acceleration sensor 205, the application processing unit 203 detects the “erecting” state if the numerical value then matches a numerical value ((0, 0, −512), for example) before the operating node 200-18 is taken up. If not, the application processing unit 203 detects that the operating node 200-18 is not in the “erecting” state.

When detecting that the operating node 200-18 is in the “erecting state” (Yes in S303), the operating node 200-18 turns off after 5 seconds (S304). For example, when detecting that the operating node 200-18 is in the “erecting state”, the application processing unit 203 instructs the LED 204 to turn off when 5 seconds elapses since the count value of the timer 206 at that time. In response to this instruction, the LED 204 turns off.

Then, the operating node 200-18 finishes a series of processing (S305).

On the other hand, when detecting that the operating node 200-18 is not in the erecting state (NO in S303), the operating node 200-18 detects whether the own node 200-18 is resting in a inclined state (S306). The operating node 200-18 performs the following process, for example.

More specifically, based on the numerical value of the acceleration sensor 205 or the count value of the timer 206, the application processing unit 203 detects a value of the X-axis or the Y-axis is equal to or larger than ±200 consecutively for 500 ms. Then, the application processing unit 203 detects that the operating node 200-18 is resting in the inclined state when a change in any of the axes is ±10 for 500 ms. When acquiring any numerical value other than that, the application processing unit 203 detects that the operating node 200-18 is not resting in the inclined state.

When detecting that the own node 200-18 is resting in the inclined state (Yes in S306), the operating node 200-18 transmits a state notice frame (S307).

Then, the operating node 200-18 transmits the state notice frame (S307), transfers the processing to S303, and repeats the processing described above.

On the other hand, when detecting that the own node 200-18 is not resting in the inclined state (No in S306), the operating node 200-18 transfers the processing to S303 and repeats the processing described above.

<2.5.5 State Notice Frame Reception Processing>

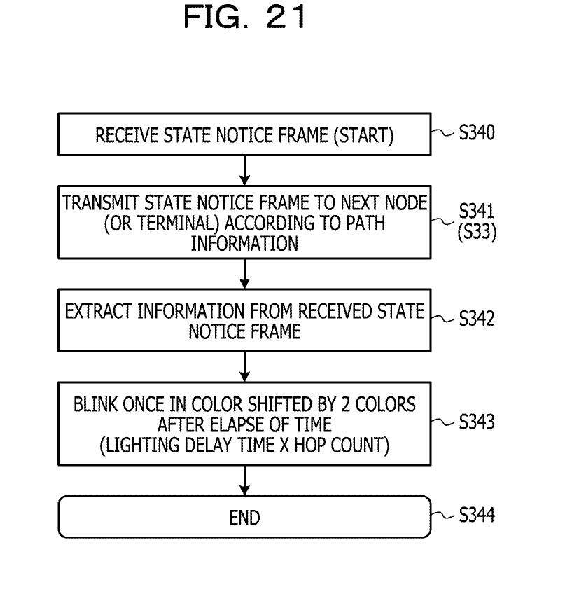

FIG. 21 is a flow chart illustrating an example of reception processing of a state notice frame in the relay nodes 200. A description is provided with the node [GW] 201-1 as the relay node 200.

When receiving the state notice frame, the node [GW] 200-1 starts the processing (S340).

Then, the node [GW] 200-1 transmits the state notice frame to the terminal 100, according to path information (S341). The node [GW] 200-1 performs the following processing, for example.

More specifically, the wireless communication processing unit 202 receives a radio signal transmitted from the node 200-2, extracts a frame from the received radio signal, and outputs the frame to the application processing unit 203. When confirming from an “LD” area of the frame received from the wireless communication processing unit 202 that a destination address is the own node 200-1, the application processing unit 203 confirms from command type information inserted in the “LD” area of the payload area that the received frame is a state notice frame. Then, the application processing unit 203 rewrites each address information included in the “LD” area and the “LS” areas of the received frame, according to the path information. The application processing unit 203 also increments the “hop count” by 1 in the header area and rewrites the “hop count” with the incremented numerical value. The application processing unit 203 outputs the rewritten state notice frame to the wireless communication processing unit 202. The wireless communication processing unit 202 converts the received state notice frame into a radio signal and transmits the converted radio signal.

Then, the node [GW] 200-1 extracts information from the received state notice frame (S342). The node [GW] 200-1 performs the following process, for example.

More specifically, the application processing unit 203 extracts a color number and lighting delay time that are inserted respectively in the “node illumination color” and the “lighting delay time”, from the payload area of the state notice frame, and the hop count that is inserted in the “the hop count”, from the header area.

Then, when the time (lighting delay time×hop count) elapses after the state notice frame is received, the node [G] 200-1 causes the LED 204 to blink once in a color that is shifted by 2 colors in each hop (S343). The node [GW] 200-1 performs the following processing, for example.

More specifically, the application processing unit 203 determines whether or not a count value of the timer 206 after the state notice frame is received from the wireless communication processing unit 202 reaches the (lighting delay time×hop count) time. The application processing unit 203 waits till the count value of the timer 206 reaches the (lighting delay time×hop count). Then, when that time is reached, the application processing unit 203 reads from the memory 207 an RGB value representing a color number that is a color number of the “node illumination color”+hop count×2. More specifically, the application processing unit 203 causes the LED 204 to emit light in a color which is different by (2×hop count) colors with respect to the illumination color inserted in the “node illumination color”. The application processing unit 203 outputs the read RGB value to the LED 204 and instructs the LED 204 to blink once. In response to this instruction, the LED 204 blinks once with the received RGB value.

As such, the respective nodes 200-17, 100-10, 200-3 to 200-1 starts blinking after the (lighting delay time×number hops) time elapses, similar to the lighting instruction frame. Therefore, in an example of FIG. 18, the nodes 200-17, 200-10, 200-3 to 200-1 emit light sequentially in this order. In addition, since each of the nodes 200 emits light in a color which is shifted by two colors in each hop, each of the nodes may blink in a mutually different color. In this case, the LED 204 may also turn off gradually through the fade-out processing or may blink while colors change gradually through the fade-in processing.

Then, the node [GW] 200-1 finishes a series of processing (S344).

<3. Mesh-Demo>

<3.1 Example of Mesh-Demo>

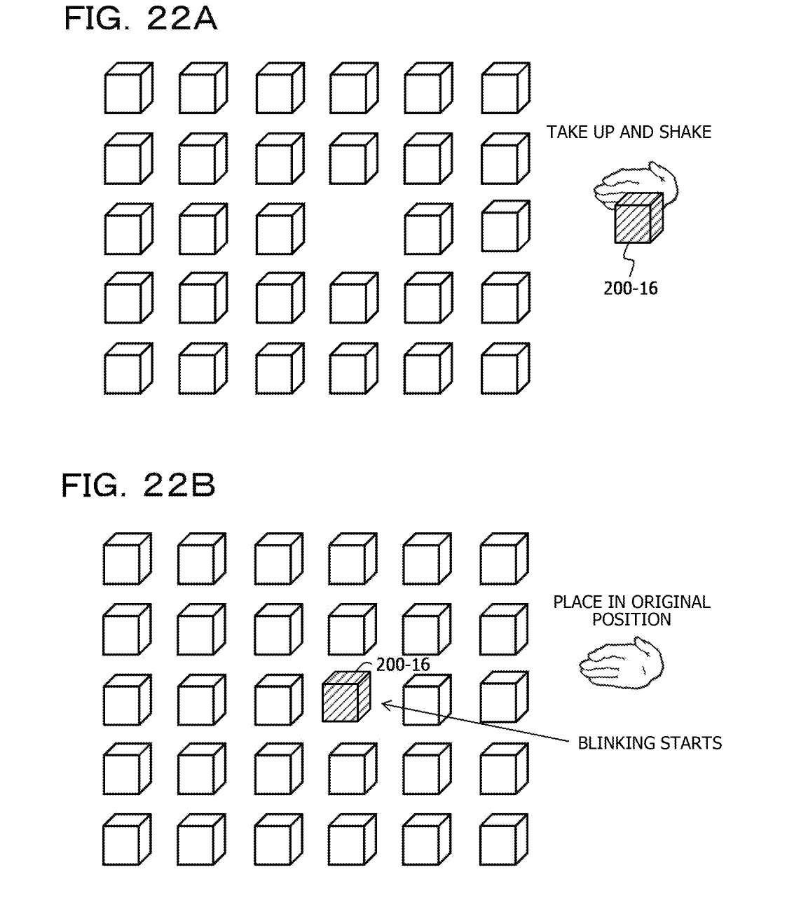

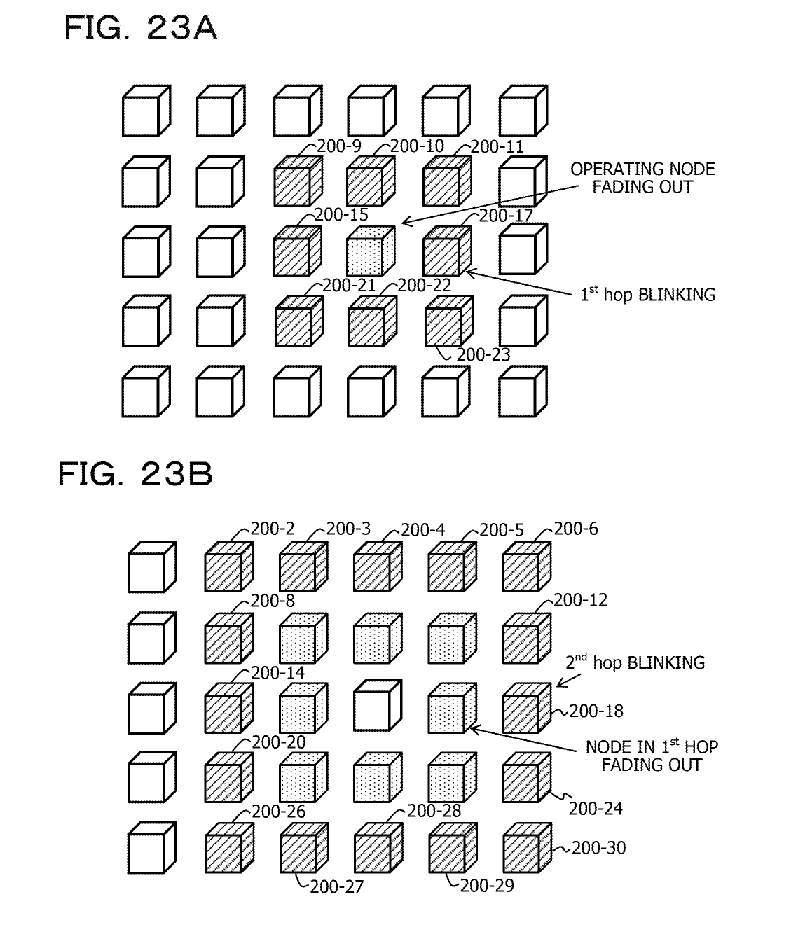

A Mesh-demo is described hereinafter. FIG. 22A to FIG. 23B are diagrams illustrating examples of the Mesh-demo.

As illustrated in FIG. 22A, during the Mesh-demo, if the user takes up and shakes a node 200-1, the node 200-16 emits light depending on a direction in which the user shakes. Then, if the user continues to shake the node 200-16, an illumination color of the node 200-16 increases intensity of the node 200-16, and is maintained for 10 seconds when the maximum intensity is reached.

Then, as illustrated in 22B, if the user places the node 200-16 during this 10 seconds, the node 200-16 starts blinking. Then, the node 200-16 generates a frame called a Mesh-demo execution frame and broadcasts the generated Mesh-demo execution frame. For example, the node 200-16 broadcasts the Mesh-demo execution frame at the intervals of 5 seconds. Furthermore, if the user takes up the node 200-16 that is in a blinking state, the node 200-16 blocks communications and the LED 204 of the node 200-6 also turns off.

As illustrated in FIG. 23A, 8 nodes of 200-9 to 200-11, 200-15, 200-17, and 200-21 to 200-23 which are the 1^{st} hop for the operating node 200-16 blink once in a color which is shifted by 2 colors t for the operating node 200-16. Then, the LED 204 of the operating node 200-16 fades out to turn off.

Then, as illustrated in FIG. 23B, 16 nodes of 200-2 to 200-6, 200-8, 200-12, 200-14, 200-18, 200-20, 200-24, and 200-26 to 200-30, which are the 2^{nd} hop for the operating node 200-16, emit light. The 16 nodes 200 in the 2^{nd} hop start emitting light in a color that is shifted by 2 colors to the 8 nodes in the 1^{st} hop. Then, the 8 nodes in the 1^{st} hop, 200-9 to 200-11, 200-15, 200-17, and 200-21 to 200-23 performs the fade-out processing.

As such, in the Mesh-demo, if the user places the operating node 200-16 after taking up and shaking the operating node 200-16, peripheral nodes sequentially repeat blinking once. The user may abort the operating node 200-16 and observe how light spreads radially.

<3.2 Mesh-Demo Execution Frame>

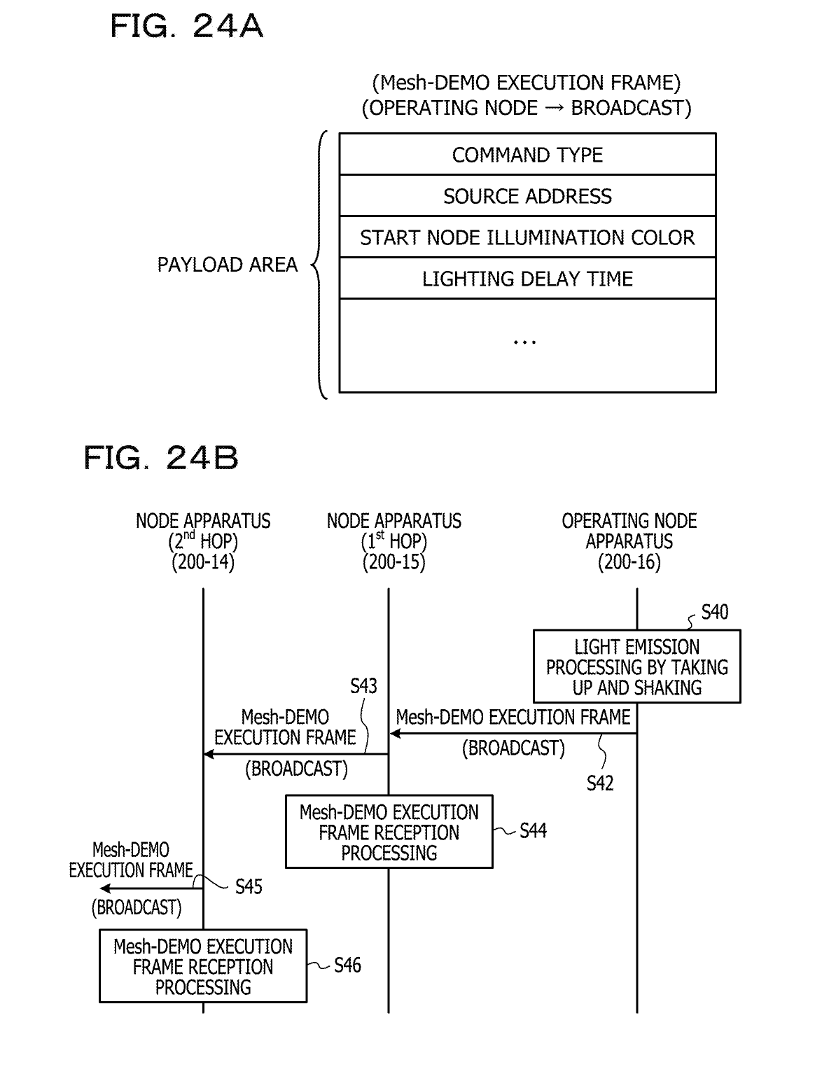

FIG. 24 is a diagram illustrating a configuration example of a Mesh-demo execution frame. The Mesh-demo execution frame includes a “command type”, a “source address”, a “start node illumination color”, and a “lighting delay time” in a payload area of the Mesh-demo execution frame.

The “command type” is an area, for example, where command type information is inserted, the command type information identifying to other types of frames that a frame is a Mesh-demo execution frame. The “source address” is an area where an address of the node (or the operating node) 200 that is taken up and shaken by the user. In an example of FIG. 22A, the address of the operating node 200-16 is inserted into the “notice source address”.

The “start node illumination color” is an area, for example, where illumination color information is inserted, the illumination color information representing a color in which the operating node 200 has emitted light. In the example of FIG. 17, a color number corresponding to the color in which the operating node 200-16 emits light is inserted in the “node illumination color”.

The “lighting delay time” is an area, for example, where time information indicating timing to cause the LED 204 to emit light in the node 200 is inserted. Similar to the “lighting delay time” of the lighting instruction frame (FIG. 15A, for example), each of the nodes 200 that receives the Mesh-demo execution frame starts blinking after the “lighting delay time”×“hop count” time elapses from receipt of the Mesh-demo execution frame.

<3.3 Example of Transfer of Mesh-demo Frame>

FIG. 24B is a sequence diagram illustrating a transfer example of a Mesh-demo execution frame. In FIG. 24B, similar to FIG. 22A, the node 200-16 shall be an operation target node, a node in the 1^{st} hop is 200-15, and a node in the 2^{nd} hop is the node 200-14, as an example.

When taken up and shaken, the operating node 200-16 performs light emission processing (S40). Details of the light emission processing are described below.

Then, the operating node 200-16 broadcasts a Mesh-demo execution frame (S42). The operating node 200-16 performs the following processing, for example.

More specifically, the application processing unit 203 reads from the memory 207 command type information representing a Mesh-demo execution frame, address information of the own station, and lighting delay time information that are stored in the memory 207. Then, the application processing area 203 reads from the memory 207 a color number representing a color in which the LED 204 is caused to emit light, as illumination color information. The application processing unit 203 generates a Mesh-demo execution frame having the information in a payload area. Then, the application processing unit 203 inserts information indicating that the frame is broadcast, into the “LD” area or the “GD” area in the header area of the Mesh-demo execution frame. The application processing unit 203 outputs the generated Mesh-demo execution frame to the wireless communication processing unit 202. The wireless communication processing unit 202 converts the received Mesh-demo execution frame into a radio signal and transmits the radio signal.

When receiving a broadcasted Mesh-demo execution frame, the node 200-15 in the 1^{st} hop broadcasts the Mesh-demo execution frame (S43). Then, the node 200-15 performs Mesh-demo execution frame reception processing (S44). Details of the Mesh-demo execution frame reception processing are described below.

When receiving the Mesh-demo execution frame broadcasted from the node 200-15 in the 1^{st} hop, similar to the node 200-15 in the 1^{st} hop, the node 200-14 in the 2^{nd} hop performs transmission of the Mesh-demo execution frame and the Mesh-demo execution frame reception processing (S45, S46), similar to the node 200-15 in the 1^{st} hop.

<3.4 Light Emission Processing>

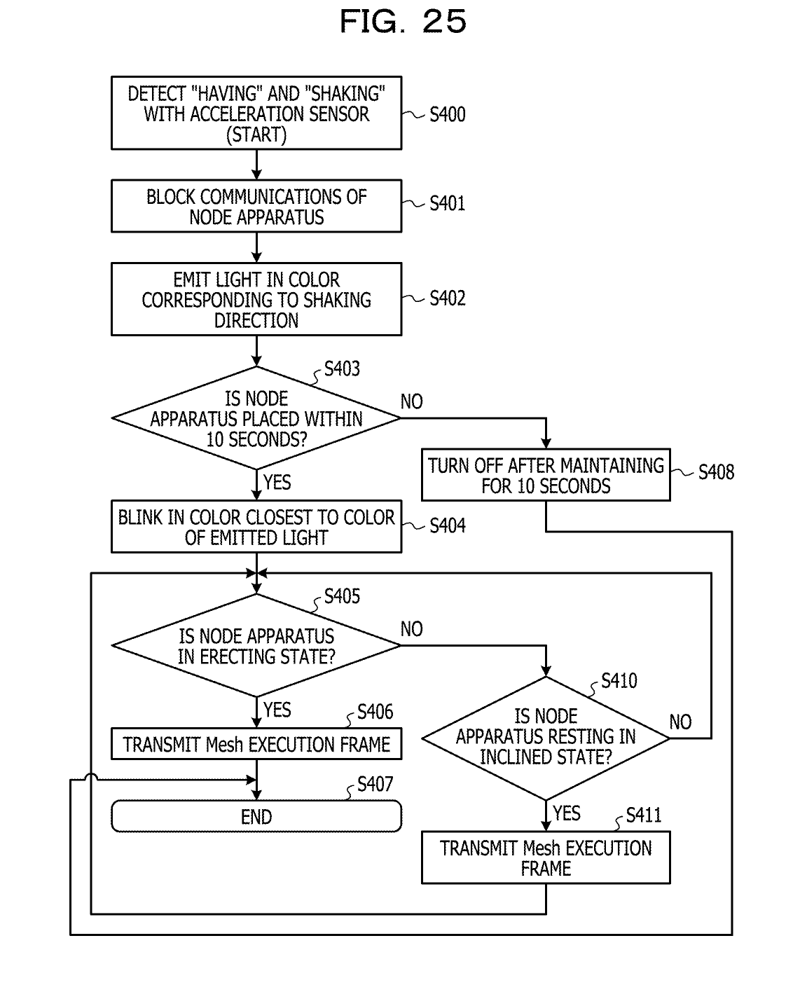

FIG. 25 is a flow chart illustrating an example of light emission processing in the operating node 200. A description is provided with the node 200-16 illustrated in FIG. 22A as the operating node 200 as an example.

The operating node 200-16 starts processing (S400) when the acceleration sensor 205 detects “having” and “shaking”. For example, based on numerical values of the X-axis, the Y-axis, and the Z-axis received from the acceleration sensor 205 and a count value from the timer 206, the application processing unit 203 detects that the own node 200-16 is in a “having” state and a “shaking” state.

Then, the operating node 200-16 blocks communications of the own node 200-16 (S401). Similar to the case of the Mesh-demo mode, when detecting “having”, the operating node 200-16 blocks communications of the wireless communication processing unit 202.

Then, the operating node 200-16 emits light in a color corresponding to a direction in which the operating node 200-16 is shaken (S402). The operating node 200-16 performs the following processing, for example.

More specifically, the memory 207 stores a table representing colors depending on a range of numerical values of the X-axis, the Y-axis, and the Z-axis acquired by the acceleration sensor 205, such as an RGB value corresponding to “white” for +300 to +310 on the X-axis, an RGB value corresponding to “yellow” from +300 to +310 on the Y-axis or the like. The application processing unit 203 reads from such a table an RGB value corresponding to the numerical value received from the acceleration sensor 205. Then, the application processing unit 203 counts a count value from when “shaking” is detected, and calculates an RGB value by increasing the intensity of the read RGB value as the count value (or time) becomes longer. As an example, the application processing unit 203 calculates (+10, +10, +10) on the read RGB value for every elapse of 1 second. With this, if the user continues to shake the operating node 200-16, the LED 204 emits light in colors corresponding to the time during which the user shakes the operating node 200-16 (or the intensity of emission color increases). In this case, if the user continues to shake, the LED 204 increases to the maximum intensity in a color corresponding to a direction in which the operating node 200-16 is shaken. The application processing unit 203 may increase the intensity of the illumination color of the LED 204 by continuing to output the calculated RGB value to the LED 204. When the calculated RGB value reaches a numerical value representing the maximum intensity, the application processing unit 203 instructs the LED 204 to continue to emit light for 10 seconds. Following the instruction, the LED 204 continues to emit light at the maximum intensity for 10 seconds.

Then, the operating node 200-16 determines whether or not the operating node 200-16 is placed within 10 seconds after the light emission at the maximum intensity (S403). For example, after instructing the LED 204 to continue to emit light for 10 seconds, the application processing unit 203 detects based on a numerical value of the acceleration sensor 205 whether or not the node 200-16 is in the “resting” state.

When the operating node is placed within 10 seconds (Yes in S403), the operating node 200-16 starts to blink in a color closest to the color of the emitted light (S404). The operating node 200-16 performs the following processing, for example.

More specifically, when detecting that the node 200-16 is in the “resting” state after emitting light at the maximum intensity, the application processing unit 203 reads an RGB value closest to the maximum intensity, from the table (FIG. 6, for example) stored in the memory 207. The application processing unit 203 outputs the read RGB value to the LED 204 and instructs the LED 204 to blink. Following the instruction, the LED 204 starts blinking in a color corresponding to the received RGB value.

Then, the operating node 200-16 detects whether or not the operating node 200-16 is in the erecting state (S405). This processing is configured to detect in what state the operating node 200-16 is placed. Similar to S303 in FIG. 20, the operating node 200-16 detects whether or not the operating node 200-16 is in the erecting state, depending on whether or not the application processing unit 203 matches a numerical value before the operating node is taken up, based on a numerical value from the acceleration sensor 205.

When the operating node 200-16 detects that the operating node 200-16 is in the erecting state (Yes in S405), the operating node 200-16 broadcasts a Mesh-demo execution frame (S406).

Then, the operating node 200-16 finishes a series of processing (S407).

On the other hand, when detecting that the operating node 200-16 is not in the erecting state (No in S405), the operating node 200-16 detects whether or not the own node 200-16 is resting in the inclined state (S410). Similar to S306 in FIG. 20, the application processing unit 203, for example, detects based on a numerical value of the acceleration sensor 205 or a count value of the counter 206.

When detecting that the operating node 200-16 is resting in the inclined state (Yes in S410), the operating node 200-16 broadcasts a Mesh-demo execution frame (S411). Then, the processing proceeds to S405 where the operating node 200-16 repeats the processing described above.

On the other hand, when the operating node 200-1 is not resting in the inclined state (No in S410), the operating node 200-16 shifts the processing to S405 and repeats the processing described above.

On the other hand, when the operating node 200-16 is not placed within 10 seconds after the LED 204 emits light at the maximum intensity (No in S403), the operating node 200-16 causes the LED 204 to turn off after 10 seconds (S408). For example, the application processing unit 203 acquires from the timer 206 time since the LED 204 emits light at the maximum intensity, and after 10 seconds elapse, instructs the LED 204 to turn off. In response to this instruction, the LED 204 turns off.

Then, the operating node 200-16 finishes a series of processing (S407).

<3.5 Mesh-Demo Execution Frame Reception Process>

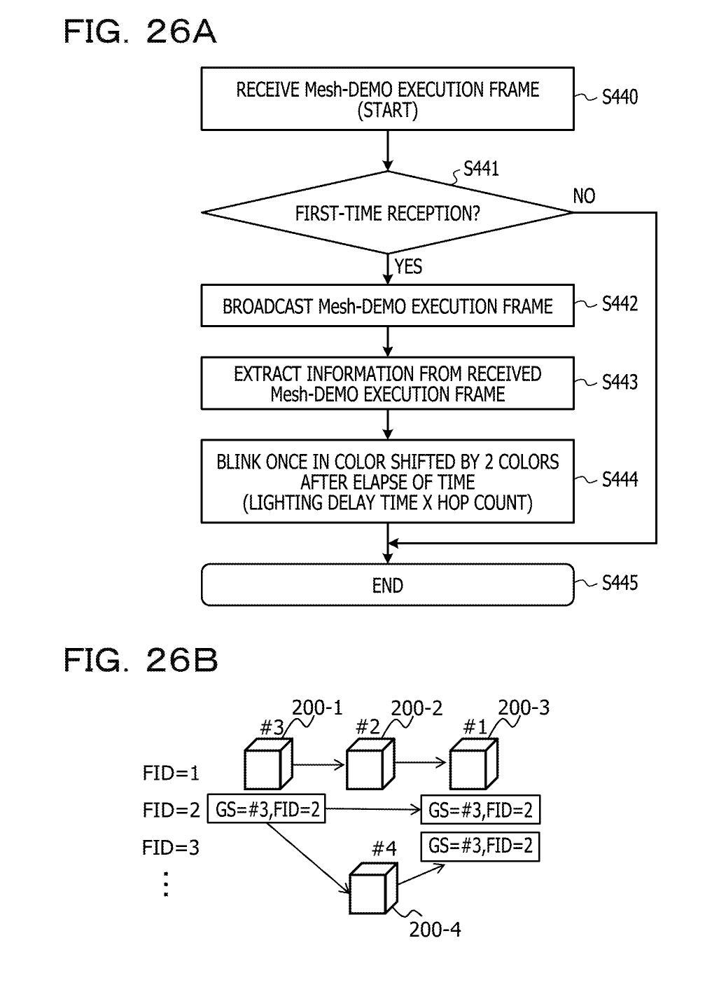

FIG. 26 (i.e. FIGS. 26A and 26B) is a diagram illustrating an operation example of Mesh-demo execution frame reception processing. A description is provided with the node 200-15 in the 1^{st} hop as an example.

When receiving a Mesh-demo execution frame, the node 200-15 starts processing (S440).

Then, the node 200-15 determines whether or not the number of receptions of the received Mesh-demo execution frame is the first time (S441).

Since each of the nodes 200 broadcasts a Mesh-demo execution frame, the node 200-15 may receive same Mesh-demo execution frame from a plurality of the nodes. In this first embodiment, based on an address (which may be hereinafter referred to as a GS) and a frame ID (which may be hereinafter referred to an FID) respectively inserted in a “GS” area and an “FID” area in the Mesh-demo execution frame, the node 200-15 determines whether or not the node 200-15 receives the same Mesh-demo execution frame (or whether or not the number of reception times is the first time).

FIG. 26B is a diagram illustrating an example of a relation between a GS and an FID. The node 200-1 generates broadcasts a Mesh-demo execution frame. The GS of this Mesh-demo execution frame is “#3” which is an address of the node 200-1, and the FID is “2”. For example, if the node 200-1 transmits a Mesh-demo execution frame again after 5 seconds, the GS is “#3” but the FID is “3”. The node 200-1 assigns a different FID to every frame generated. The Mesh-demo execution frame with the GS of “#3” and the FID “2” is broadcasted and received by the node 200-2 and the node 200-4. The two nodes 200-2 and 200-4 broadcast the Mesh-demo execution frame with the GS of “#3” and the FID of “2”. From the two nodes 200-2 and 200-4, the node 200-1 receives a same Mesh-demo execution frame with the GS of “#3” and the FID of “2”. In this case, the node 200-3 performs processing on the first received Mesh-demo execution frame from the node 200-2 and then terminates (or discards) the M-demo execution frame next received from the node 200-3. The Mesh-demo execution frame first received from the node 200-2 is the frame received for the first time and the Mesh-demo execution frame next received from the node 200-3 is the frame received for the second time.

For example, if a GS is different, the Mesh-demo execution frame is a Mesh-demo execution frame generated at a node that is not the node 200-1. In addition, when an FID is different even if a GS is same, the frame is a Mesh-demo execution frame transmitted at different timing. As such, the node 200-3 may determine the number of reception of Mesh-demo execution frames by using a combination of a GS and an FID.

With reference back to FIG. 26A, the node 200-15 in the 1^{st} hop performs the following processing in S441.

More specifically, the application processor 203 reads a GS and an FID respectively inserted in the “GS” area and the “FID” area of the received Mesh-demo execution frame. In addition, the application processing unit 203 determines whether or not any Mesh-demo execution frame with both GS and FID being same is stored in the memory 207. If there is no Mesh-demo execution frame with the same GS and FID, the application processing unit 203 determines that reception is the first time. If there is any Mesh-demo execution frame with the same GS and FID, the application processing unit 203 determines that reception is not the first time.

When determining that the received Mesh-demo execution frame is received for the first time (Yes in S441), the node 200-15 broadcasts the Mesh-demo execution frame (S442). The node 200-15 performs the following processing, for example.

More specifically, when receiving a radio signal, the wireless communication processing unit 202 extracts a frame from the received radio signal and outputs the frame to the application processing unit 203. The application processing unit 203 confirms that a destination address inserted in the “LD” area of the frame is broadcast, and confirms from command type information inserted in the “command type” of the payload area that the received frame is a Mesh-demo execution frame. With this, processing in S440 is performed. Then, the application processing unit 203 also confirms that the Memo-demo execution farms is the first-time Mesh-demo execution frame transmitted from the operating node 200-16. The application processing unit 203 rewrites address information of the own node 200-15 with address information inserted in the “LS” area of the received frame, and outputs the rewritten Mesh-demo execution frame to the wireless communication processing unit 202. The wireless communication processing unit 202 transmits the received Mesh-demo execution frame.

Then, the node 200-15 extracts information from the received Memo-demo execution frame (S443). For example, the application processing unit 203 extracts illumination color information and lighting delay time information, respectively, from the “start node illumination color” and the “lighting delay time” of the Mesh-demo execution frame that is determined to be the first time reception, and extracts the hop count inserted in the header area.

Then, the node 200-15 causes the LED 204 to blink once in a color shifted by 2 colors for one hop after the (lighting delay time×number of times) elapses. For example, the application processing unit 203 waits till a count value of the timer 206 elapses for the (lighting delay time×number hops) time, and, after the elapse, reads an RGB value representing a color number of “node illumination color”+hop count×2 from the memory 207, and outputs the RGB value to the LED 204. With this, following the instruction from the application processing unit 203, the LED 204 starts blinking in the color shifted by 2 colors for 1hop.

Then, the node 200-15 finishes a series of processing (S445).

On the other hand, if the received Memo-demo execution frame is not the first-time reception (No in S441), the node 200-15 finishes a series of processing without performing processing on the Mesh-demo execution frame (S445). For example, the application processing unit 203 finishes the processing by terminating (or discarding) the Mesh-demo execution frame received the second time or later.

<4. 1Hop-Demo>

<4.1 Example of 1Hop-Demo>

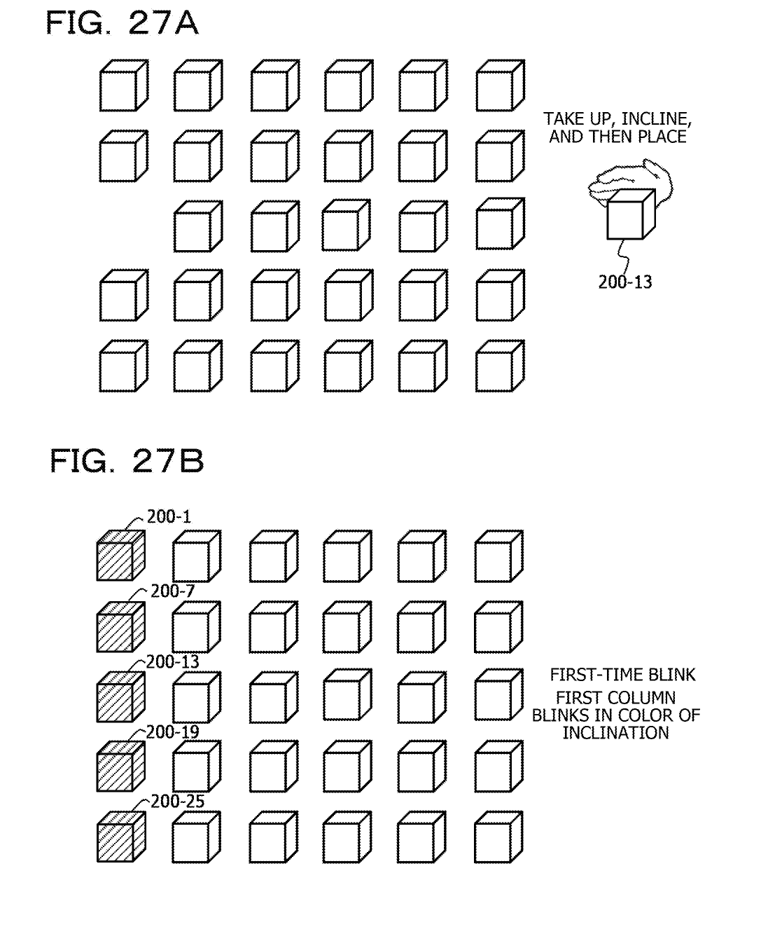

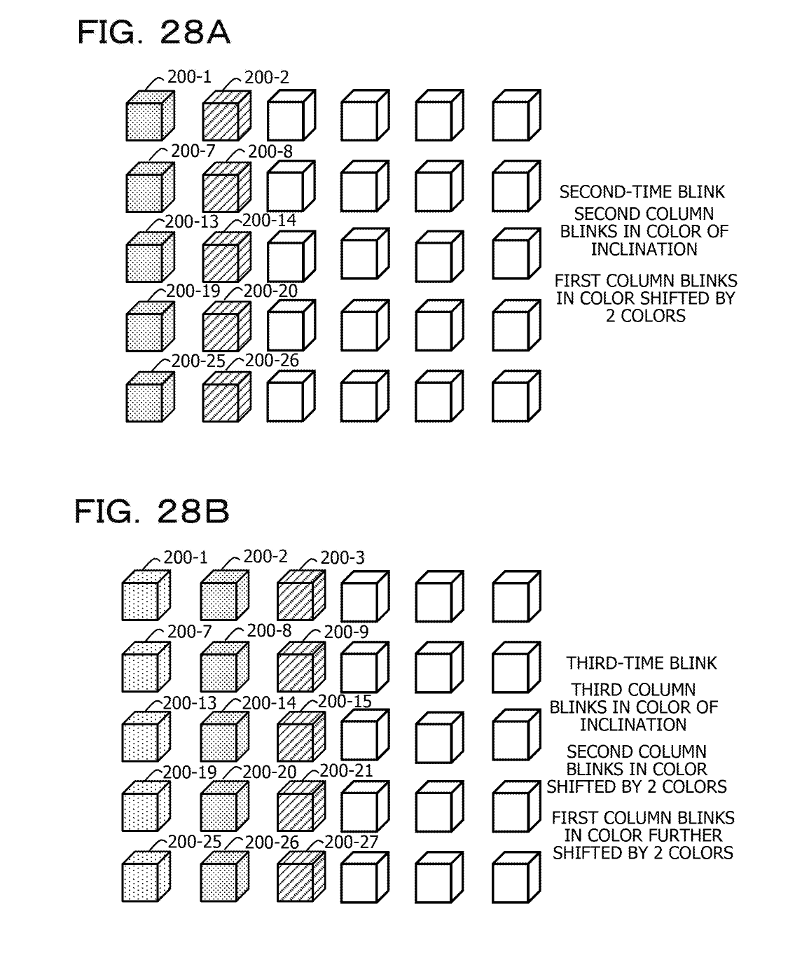

A 1hop-demo is described hereinafter. FIG. 27A to FIG. 28B are diagrams illustrating examples of the 1hop-demo.

As illustrated in FIG. 27A, during a 1hop-demo, if the user takes up and inclines the node 200-13, the node 200-13 emits light in a color corresponding to the inclination. For example, the node 200-13 is in the erecting state after emitting light, and then turns off after 5 seconds.

As illustrated in FIG. 27B, if the user places the light-emitting node 200-13 on a floor or the like, the node 200-13 executes the following types of demos, depending on a direction in which the node 200-13 is inclined.

(A) Inclined to the left→Starting a demo of a curtain pattern (left direction)

(B) Inclined to the right→Starting a demo of a curtain pattern (right direction)

(C) Inclined to the front→Starting a demo of a ripple pattern in red

(D) Inclined to the back→Starting a demo of a ripple patter in blue

FIG. 27A to FIG. 28B represent a situation in which a curtain pattern (right direction) demo is performed because the node 200-13 is inclined to the right. Furthermore, in the direction depicted in FIG. 7A, for example, the inclined directions are as follows: Y-axis + direction is “inclined to the right”, Y-axis − direction is “inclined to the left”, X-axis − direction is “inclined to the front”, and the X-axis + direction is “inclined to the back”. For example, the acceleration sensor 205 makes it possible to detect a numerical value of the X-axis and the Y-axis, and a numerical value detected by the application processing unit 203 makes it possible to detect “inclined to the right” or the like.

As illustrated in FIG. 27B, if the user places the light emitting node 200-13 on a floor or the like for 5 seconds after light emission, as first-time blink, the nodes 200-1, 200-7, 200-13, 200-19, and 200-25 in the first column start blinking. In this case, the respective nodes 200-1, 200-7, 200-13, 200-19, and 200-25 blink in a color in which the node 200-1 emits light. Then, the light emitting node 200-13 generates a frame called a 1hop-demo execution frame and broadcasts the 1hop-demo execution frame. Details of the 1hop demo execution frame are described below.

Then, as illustrated in FIG. 28A, as second-time blink, the nodes 200-2, 200-8, 200-14, 200-20, and 200-25 in the second column start blinking. In this case, the nodes in the second column 200-2, 200-8, 200-14, 200-20, and 200-26 blink in a color in which the node 200-13 emits light when the node 200-13 is inclined. In addition, the nodes in the first column, the nodes 200-1, 200-7, 200-13, 200-19, and 200-25 start blinking in a color shifted by 2 colors to the color in which the second column nodes 200-2, 200-8, 20-14, 200-20, and 200-26 blink.

Then, as illustrated in FIG. 28B, as third blink, the nodes in the third column, 200-9, 200-15, 200-21, and 200-27 start blinking. In this case, the nodes in the third column 200-3, 200-9, 200-15, 200-21, and 200-24 blink in a color in which the node 200-13 is inclined. In addition, the nodes 200-2, 200-8, 220-14, 200-20, and 200-26 in the second column start blinking in a color shifted by 2 colors to the color in which the nodes 200-3, 200-9, 200-15, 200-21, and 200-27 in the third column blink. Furthermore, the nodes in the first columns 200-1, 200-7, 200-13, 200-19, and 200-25 start blinking in a color shifted by 2 colors to the color in which the second column nodes 200-2, 200-8, 200-14, 200-20, and 200-26 blink. Then, each of the nodes 200 sequentially starts blinking in the unit of a column.

Thus, in a 1hop-demo, the user may observe how each of the nodes emits light like a curtain call. A demo of a ripple pattern is described below.

Furthermore, during the 1hop-demo, each of the nodes 200 has position information and that position information may not be changed. This is because each of the nodes 200 is configured to cause the LED 204 to emit light based on the position information, as described below.

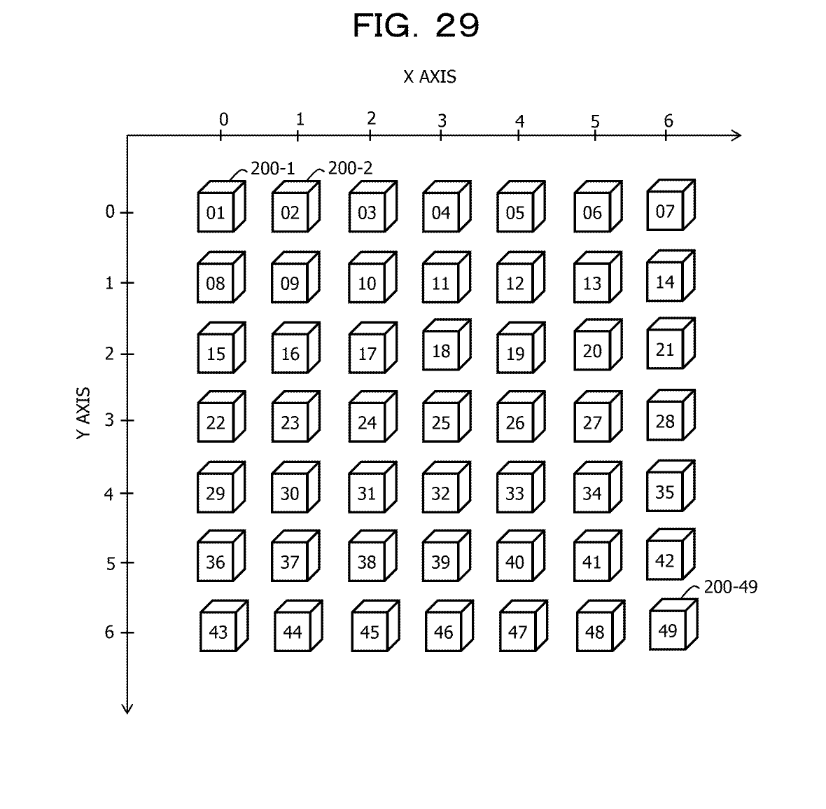

FIG. 29 illustrates an example of position information. When coordinates of the X-axis and the Y-axis are set as illustrated in FIG. 29, the address of the node 200-1 paced at position of (0, 0) (=X-axis, Y-axis) is “01”, and the address of the node 200-2 placed at the position of (1, 0) is “49”. The position information is information that associates the address of each of the nodes 200 that are thus set with positional coordinates of the X-axis and the Y-axis. Therefore, the position information of the node 20-1 is a pair of (0, 0) and the address “01” and the node 200-1 is not allowed to change this position information. In the 1hop-demo, each of the nodes 200 determines timing of blinking using the position information and a demo-pattern.

Furthermore, the positional coordinates and the address values depicted in FIG. 29 are an example. For example, if the position information of each of the nodes 200 is identifiable, other positional coordinate or other address value may be acceptable. In addition, in FIG. 29, for example, a direction that the battery indicator 216 placed on a surface of the node 200 faces shall be a front direction (FIG. 7A, for example) and an axis parallel to the front direction shall be an X-axis. An axis that is perpendicular to that X-axis on a horizontal plane shall be a Y-axis.

<4.2 1Hop-Demo Execution Frame>

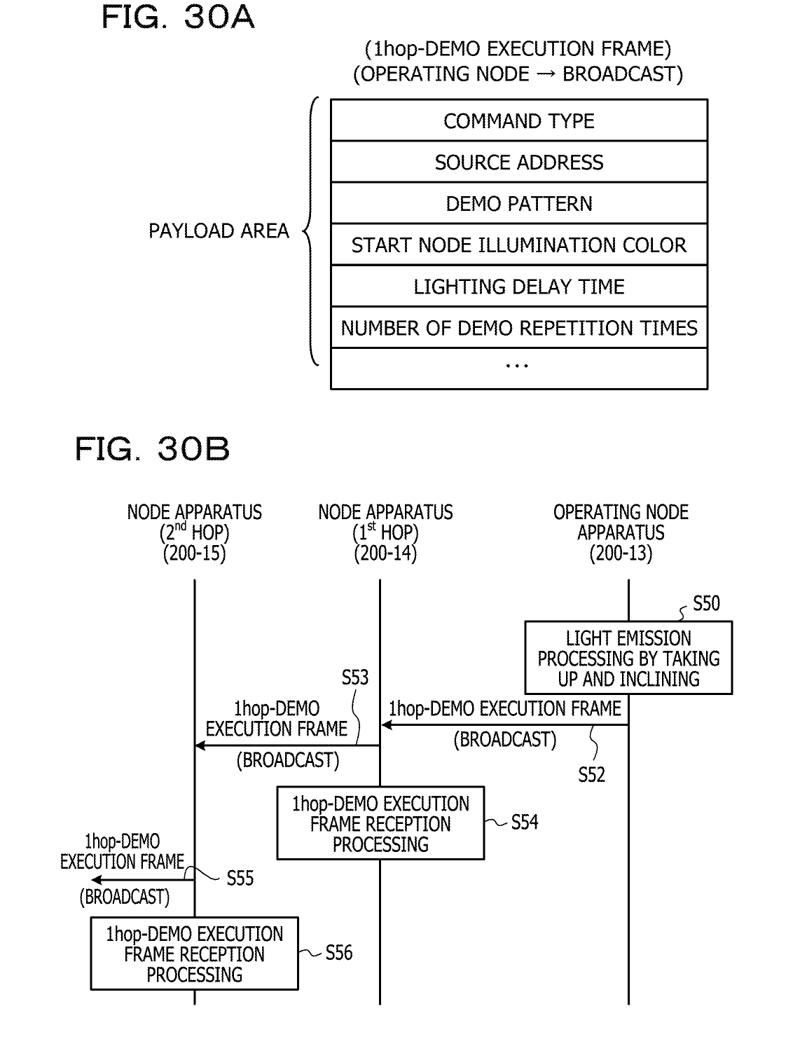

FIG. 30A is a diagram illustrating a configuration example of a 1hop-demo execution frame. The 1hop-demo execution frame includes a “command type”, a “source address”, a “demo-pattern”, a “start node illumination color”, “lighting delay time”, and a “number of demo repetition times” in a payload area of the 1hop-demo execution frame.

The “command type” is an area where command type information is inserted, the command type information identifying to other types of frames that a frame is a 1hop-demo execution frame. The “source address” is an area where an address of a node (or operating node) 200 taken up and shaken by the user is inserted. In the example of FIG. 27A, the address of the operating node 200-13 is inserted in the “source address”.

The “demo-pattern” is an area where demo pattern information identifying a curtain pattern (left direction), a curtain pattern (right direction), and a ripple pattern is inserted. For example, in the case of “0”, the demo-pattern is the curtain pattern (left direction), in the case of “1”, the curtain pattern (right direction), and in the case of “2”, the ripple pattern, or the like.

The “start node illumination color” is an area where light emission information representing a color in which the node 200 has emitted light is inserted. In the example of FIG. 27A, a color number of the light emitted by the operating node 200-13 is inserted in the “node illumination color”.

The “lighting delay time” is an area where time information indicating timing to cause the LED 204 to emit light is inserted. Each of the nodes 200 emits light after time of the “lighting delay time”×a (difference between X coordinate of a demo-origin address and X coordinate of the own node 200) elapses. Details are described below.

The “number of demo-repetition times” is an area where, for example, information indicating the number of times to repeat a demo is inserted. In the example of FIG. 27A to FIG. 28B, for example, the number of demo-repetition times from when the nodes 200 in the first column start blinking till the nodes in the sixth column start blinking shall be “1”. If the number of demo-repetition times is set to “3”, this is repeated three times.

<4.3 Example of Transfer of 1Hop-Demo Execution Frame>

FIG. 30B is a diagram illustrating a transfer example of a 1hop-demo execution frame. In FIG. 30B, a description is provided with the node 200-13 as an operating node, the node 200-14 as a node in a 1^{st} hop, and the node 200-15 in a 2^{nd} hop, as an example, similar to FIG. 27A.

The operating node 200-13 performs light emission processing (S50) when the operating node 200-13 is taken up and inclined. Details of the light emission processing are described below.

Then, the operating node 200-13 broadcasts a 1hop-demo execution frame (S52). The operating node 200-13 performs the following processing, for example.

More specifically, the application processing unit 203 reads from the memory 207 command type information indicating a 1hop-demo execution frame, address information of own station, lighting delay time information, and the number of demo-repetition times that are stored in the memory 207. Then, the application processing unit 203 reads from the memory 207 a color number representing a color in which the LED 204 is caused to emit light. The application processing unit 203 generates a 1hop-demo execution frame including the information in the payload area and outputs the 1hop-demo execution frame to the wireless communication processing unit 200. Furthermore, the application processing unit 203 inserts into a header area of the 1hop-demo execution frame information indicating that a “GD” and a “LD” are broadcast. The wireless communication processing unit 202 converts the received 1hop-demo execution frame into a radio signal and transmits the radio signal.

When receiving the broadcasted 1hop-demo execution frame, the node 200-14 in the 1^{st} hop broadcasts the 1hop-demo execution frame (S53). The node 200-14 performs the following processing, for example.

More specifically, when receiving the radio signal, the wireless communication processing unit 202 extracts the 1hop-demo execution frame from the received radio signal and outputs the 1hop-demo execution frame to the application processing unit 203. The application processing unit 203 confirms that an address indicated by the “LD” or the “GD” in the header area of the 1hop-demo execution frame is broadcast. In addition, the application processing unit 203 confirms that the command type information inserted in the “command type” in the payload area is information representing the 1hop-demo execution frame, and also confirms that the received 1hop-demo execution frame is the 1hop demo-execution frame of the first time. Similar to the case of a Mesh-demo execution frame, when receiving the 1hop-demo execution frame of the first time, each of the nodes 200 broadcasts the 1hop-demo execution frame. In this case, when receiving a 1hop-demo execution frame of second time or later, each of the nodes 200 terminates (or discards) and does not transmit the 1hop-demo execution frame.

Then, the node 200-14 in the 1^{st} hop performs 1hop-demo execution frame reception processing (S54). Details of the 1hop-demo execution frame reception processing are described below.

When receiving the broadcasted 1hop-demo execution frame from the node 200-14 in the 1^{st} hop, the node 200-15 in the 2^{nd} hop broadcasts the 1hop demo execution frame and performs the 1hop demo execution frame reception processing (S55, S56).

<4.4 Light Emission Processing>

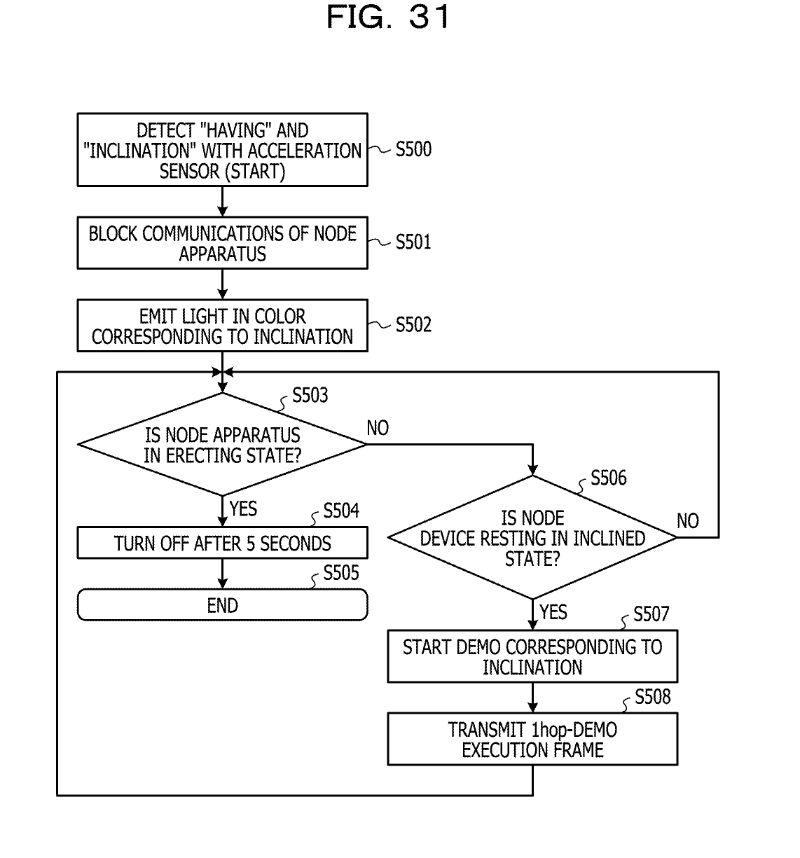

FIG. 31 is a flow chart illustrating an example of light emission processing in the operating node 200. A description is provided with the node 200-13 depicted in the example of FIG. 27A as the operating node 200.

When detecting “having” and “inclination” with the acceleration sensor 205, the operating node 200-13 starts processing (S500). For example, the application processing unit 203 detects “having” and “inclination”, based on numerical values of the X-axis, the Y-axis, and the Z-axis that are received from the acceleration sensor 205 and a count value from the timer 206.

Then, the operating node 200-13 blocks communications of the own node 200-13 (S501).

Then, the operating node 200-13 emits light in a color according to inclination (S502). For example, similar to S302 of FIG. 20, the application processing unit 203 acquires an RGB value based on the values acquired from the acceleration sensor 205 and a table stored in the memory 207 and outputs the RGB value to the LED 204. With this, the LED 204 emits light according to the inclination.

Then, the operating node 200-13 detects whether or not the operating node 200-13 is in the erecting state (S503). For example, similar to S303 of FIG. 20, the application processing unit 203 detects a “resting” state based on the numerical value from the acceleration sensor 205, and detects the “erecting” state if the numerical value matches a numerical value before the operating node is taken up.

When detecting that the operating node 200-16 is in the erecting state (Yes in S503), the operating node 200-16 causes the LED 204 to turn off light when 5 seconds passes after light emission. For example, when detecting that the operating node 200-16 is in the erecting state, the application processing unit 203 causes the LED 204 to turn off light when a count value of the timer 206 from that point in time passes 5 seconds.

Then, the operating node 200-13 finishes a series of processing (S505).

On the other hand, when detecting that the operating node 200-13 is not in the erecting state (No in S503), the operating node 200-13 detects whether or not the own node 200-13 is resting in an inclined state (S506). For example, similar to S306 of FIG. 20, the application processing unit 203 detects whether or not the operating node 200-13 is resting in the inclined state, based on numerical values of the acceleration sensor 205 or a count value of the timer 206.

When detecting that the operating node 200-13 is resting in the inclined state (Yes in S506), the operating node 200-13 starts a demo corresponding to inclination (S507). For example, the application processing unit 203 detects inclination of the own node 200-13 depending on a numerical value acquired from the acceleration sensor 205, and reads from the memory 207 a demo type (any of (A) to (D) described above) corresponding to the detected inclination. Then, the application processing unit 203 starts the demo. In the example described above, the application processing unit 203 starts processing of the curtain call (right direction). Then, the application processing unit 203 inserts information indicating a demo type in the “demo-pattern” of the 1hop-demo execution frame. This makes it possible to give an instruction on what demo to cause other nodes 200 to perform, for example.

Then, the operating node 200-13 broadcasts the 1hop-demo execution frame (S508), shifts the processing to S503, and repeats the processing described above.

On the other hand, when detecting that the own-node 200-13 is not resting in inclined state (No in S506), the operating node 200-13 shifts the processing to S503 and repeats the processing described above.

<4.5 1hop-demo Execution Frame Reception Process>

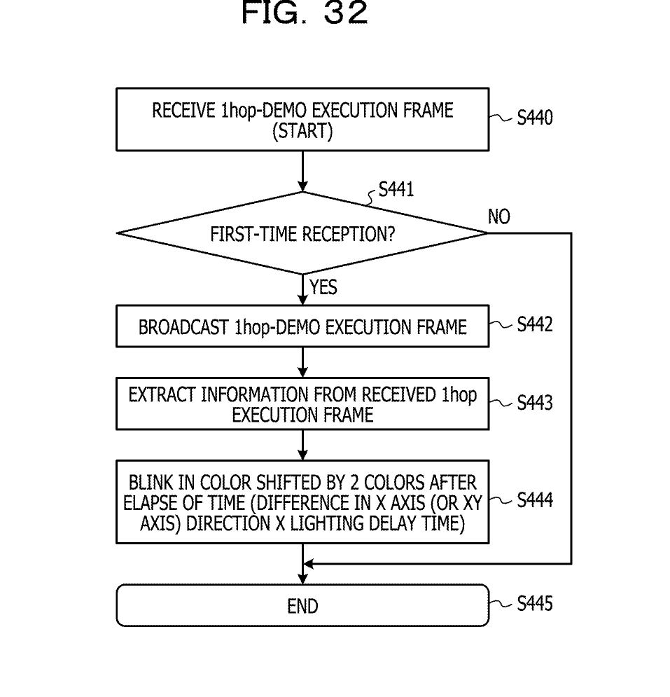

FIG. 32 is a diagram illustrating an operation example of a 1hop-demo execution frame reception processing. A description is provided with the node 200-14 as a node in a 1^{st} hop in a demo-pattern of the curtain call (right direction).

When receiving a 1hop-demo execution frame, the node 200-14 starts processing (S540).

Then, the node 200-14 determines whether or not the received 1hop-demo execution frame is received for the first time (S541). For example, similar to S441 of FIG. 26, the application processing unit 203 determines whether the 1hop-demo execution frame is received for the first time or the second time or later, based on a GS and an FID which are inserted respectively in the “GS” and the “FID”.

When determining that the received 1hop-demo execution frame is received for the first time (Yes in S541), the node 200-14 broadcasts the 1hop-demo execution frame (S442).

Then, the node 200-14 extracts information from the received 1hop-demo execution frame (S543). For example, the application processing unit 203 extracts each piece of information inserted in a “source address”, a “demo-pattern”, a “start node illumination color”, a “lighting delay time”, and a “number of demo-repetition times” in the payload area of a Mesh-demo execution frame that is determined to be received for the first time. For example, the application processing unit 203 executes demo-patterns from (A) to (D) described above, according to the demo-pattern.

Then, when time elapsed from receipt of the 1hop-demo execution frame reaches (difference in the X-axis direction×lighting delay time), the node 200-14 causes the LED 204 to emit light in a color shifted by 2 colors for every hop (S544). The node 200-14 performs the following processing, for example.

More specifically, the application processing unit 203 acquires an address of the operating node 200-13, which is a demo origin, from the “source address” (“15”, for example). The memory 207 also stores X-axis coordinates and Y-axis coordinates (x, y) corresponding to each address. The application processing unit 203 reads the X-axis coordinates (“0”, for example) corresponding to the address of the operating node 200-13 from the memory 207. The application processing unit 203 also reads the Y-axis coordinates (“1”, for example) corresponding to the address (“16”, for example) of the own node 200-14 from the memory 207. The application processing unit 203 determines a difference (=difference in the X-axis direction) (“1”, for example) between the X-axis coordinates (“0”, for example) of the operating node 200-13 and the X-axis coordinates (“1”, for example) of the own node 200-14. Then, the application processing unit 203 multiples the determined difference in the X-axis direction by the lighting delay time. In the case of the node 200-14, 1×lighting delay time. More specifically, blinking starts after elapse of the lighting delay time from the timing when the operating node 200-13 is placed.

Furthermore, if the node in the 1^{st} hop is the node 200-7, an address is “08”, for example (FIG. 29, for example). In this case, coordinate of the X-axis of the node 200-7 is “0”, and a difference of the operating node with respect to the X-axis coordinates “0” is “0”. Therefore, light emission timing of the node 200-7 is 0×lighting delay time=0, and starts blinking at the almost same timing as the timing when the operating node 200-13 is placed and starts blinking. Also in the case of other nodes in the first column 200-1, 200-19, and 200-25, since a difference of the X coordinate to the operating node 200-13 is “0”, the nodes 200-1, 200-19, and 200-25 also start blinking at the almost same timing as the timing when the operating node 200-13 starts blinking.

Furthermore, the node 200-13 blinks for the first time in a color that is same as the color in which the operating node 200-13 blinks. The node 200-13 blinks for the second time in a color that is shifted by 2 colors with respect to the blinking for the first time. The node 200-13 blinks for the third time in a color that is further shifted by 4 colors. For example, for the “start node illumination color”, the application processing unit 203 reads from the memory 207 an RGB value corresponding to the same color number for blinking for the first time, an RGB value corresponding to (the color number of the first time)×2, for the second time, and an RGB value corresponding to (the color number of the first time)×4, for the third time. Then, the application processing unit 203 outputs the read RGB values to the LED 204 and instructs the LED 204 to blink. In response to this instruction, the LED 204 starts blinking with the instructed RGB values. For example, the application processing unit 203 may cause the LED 204 to blink in a color corresponding to a difference of positional coordinates.

Then, the node 200-13 finishes a series of processing (S545).

Also for a case where a demo-pattern is the curtain call (left direction), if the operating node 200 is the node 200-18, the nodes 200-6, 200-12, 200-24, and 200-30 in the same column as the node 200-18 have a difference in the X-axis direction of “0”. Therefore, the nodes in the first column of the operating node 200-18, which are the nodes 200-6, 200-12, 200-24, and 200-30, may start blinking at the almost same timing as the timing when the operating node 200-18 is placed and starts blinking. Subsequently, each of the nodes 200 starts blinking, with the start timing shifted depending on the difference in the X-axis direction.

When a demo-pattern is the ripple pattern, with the address of the operating node 200 as a demo-origin address, each of the nodes 200 calculates a difference (or distance) between coordinates (x1, y1) of the operating node 200 and coordinates (x2, y2) of the own node 200. Then, in processing of S544, each of the nodes 200 starts blinking after elapse of the difference of the XY-axis directions×the lighting delay time. Each of the nodes 200 first emits light in a same color as the operating node 200, and then blinks multiple times while shifting a color by 2 colors, which is similar to the example of the curtain pattern. For example, for a color number of the “start node illumination color”, the application processing unit 203 calculates a color number of the number of blinks×2, and causes the LED 204 to emit light with an RGB value corresponding to that color number.

<5. Restart Frame>

Lastly, a restart request frame is described. The restart request frame is a frame with which the terminal 100 requests each of the nodes to restart, for example. The node 200 that receives the restart request frame restarts after time specified with the restart request frame elapses.

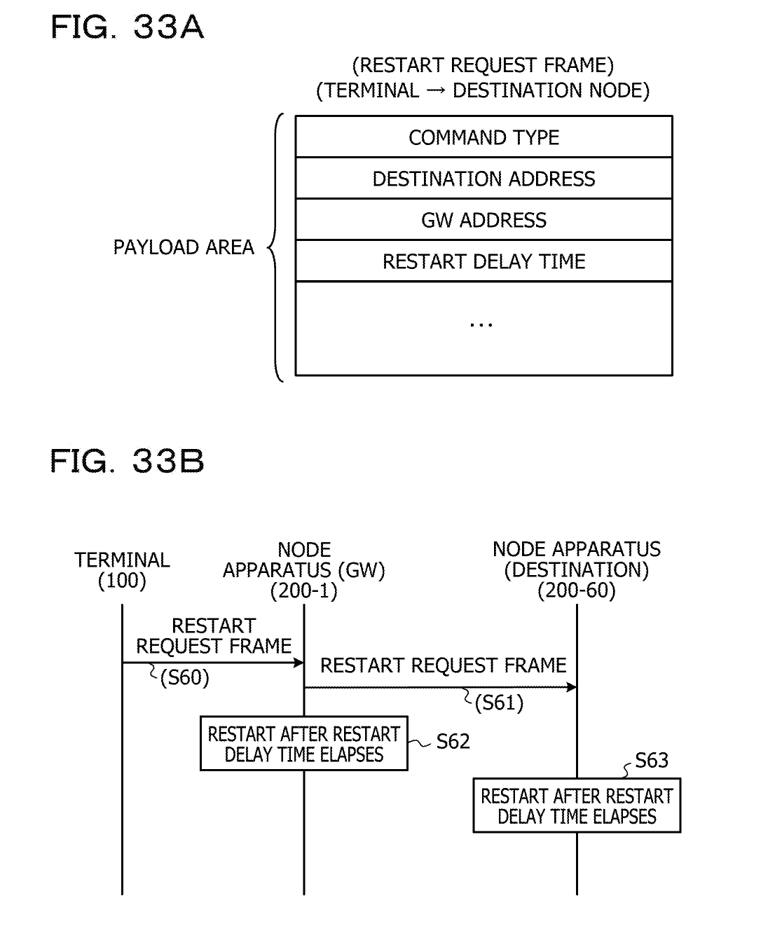

FIG. 33A is a diagram illustrating a configuration example of the restart request frame. The restart request frame includes a “command type”, a “destination address”, a “GW address”, and “restart delay time” in a payload area of the restart request frame.

The “command type” is an area where command type information is inserted, the command type information identifying to other types of frames that a frame is a restart request frame. For example, the “destination address” is an area where address information of the node 200 that is a final destination in path information is inserted. In addition, the “GW” address is an area where address information of the node [GW] 200, for example, is inserted.

The “restart delay time” is an area where restart delay time information is inserted, the restart delay time information indicating time that the node 200 starts to restart after receiving the restart request frame. Each of the nodes 200 performs restarting when the time indicated in the restart delay time information elapses after the restart request frame is received.

FIG. 33B is a diagram illustrating a transfer example of a restart request frame. The terminal 100 generates and transmits a restart request frame (S60). The terminal 100 performs the following processing, for example.

More specifically, the application processing unit 103 reads from the memory 113 command identification information identifying that a frame is the restart request frame, address information of the node 200 that is a final destination in path information, and restart delay time information. Then, the application processing unit 203 generates a restart request frame including the information in a payload area and outputs the restart request frame to the wireless communication processing unit 102. The wireless communication processing unit 102 transmits the received restart request frame.

When receiving the restart request frame, the node [GW] 200-1 adds an area in which an address of the own node [GW] 200-1 is “GS” and an address of the destination node is “GD”. Then, the node [GW] 200-1 rewrites an “LS” and an “LD” of the restart request frame based on the path information and transmits the restart request frame (S61). The node [GW] 200-1 performs the following processing, for example.

More specifically, when receiving a radio signal, the wireless communication processing unit 202 extracts a frame from the received radio signal, and outputs the frame to the application processing unit 203. The application processing unit 203 confirms that address information inserted in the “LD” area of the received frame is the own node [GW] 200-1 and determines from the command type information included in the payload area that the received frame is a restart request frame. Then, the application processing unit 203 extracts restart delay time information from the payload area, stores the restart delay time information in the memory 207, and starts counting a count value of the timer 206. The application processing unit 203 also rewrites the LD and the LS of the restart request frame according to the path information, and outputs rewritten restart request frame to the wireless communication processing unit 202. The wireless communication processing unit 202 transmits the received restart request frame.

A destination node 200-60 receives the restart request frame and terminates the received restart request frame. Then, the respective nodes 200-1 and 200-60 performs restarting concurrently (S62, S63) after restart request time elapses. Also in the address node 200-60, for example, the application processing unit 203 stores in the memory 207 restart delay time information from the payload area of the received restart request frame and starts counting a count value of the timer 206. Then, the application processing units 203 of the respective nodes 200-1 and 200-60 starts to perform restarting when the count time reaches the restart request time.

The first embodiment is described as above. The first embodiment has the following effects, for example.

More specifically, as described in the path-demo, the node 200 causes the LED 204 to emit light, based on the lighting delay time included in the lighting instruction frame that is transferred according to path information. The lighting instruction frame is relayed through the node 200 according to the path information and reaches the node 200 that is a destination. Therefore, as illustrated in FIG. 14, for example, it is possible to visualize a communication path by wires communications. Even when the operating node 200 emits light in a path-demo, a state notice frame is relayed through the node 200 according to the path information and transmitted to the terminal 100. Thus, as illustrated in FIG. 18, for example, it is possible to visualize a communication path by wireless communications. Furthermore, even in the case of a Mesh-demo or 1hop-demo, a Mesh-demo execution frame or a 1hop-demo execution frame is broadcasted, and the node 200 that receives these frames causes the LED 204 to emit light based on the lighting delay time. Thus, as illustrated in FIG. 23A and FIG. 23B, and FIG. 28A and FIG. 28B, for example, a communication path by wireless communications in broadcast is visualized.

In addition, in any demo-pattern, the terminal 100 or the node 200 simply transmits or receives a frame wirelessly, and no physical cable is connected to the respective nodes 200 separately. Therefore, in the wireless network system 10, visualization is easily possible without incurring cost.

Furthermore, if the respective nodes 200 are placed in a range that allows the nodes to communicate with each other, it is possible that the nodes 200, placed, as a whole, in a variety of shapes such as a circle or straight line, emit lights along a communication path of wireless communications. For example, the respective nodes 200, immediately after being installed in a concert venue or a wedding center and caused to emit light along a communication path of wires communications, may be installed in a different concert venue or a wedding center and caused to emit light, without separately removing or wiring cables.

In addition, various demo-patterns makes it possible to entertain users.

### Second Embodiment

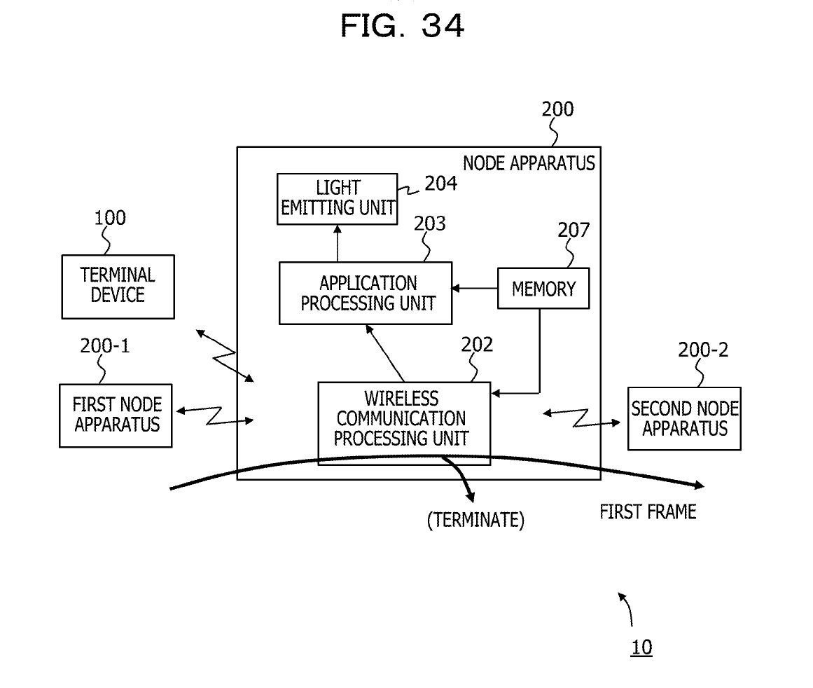

A second embodiment is described hereinafter. FIG. 34 is a diagram illustrating a configuration example of a wireless network system in the second embodiment.

A wireless network system 10 includes a terminal apparatus 10, and a plurality of node apparatuses 200-1, 200, and 200-2. The node apparatus 200 includes a wireless communication processing unit 202 and an application processing unit 203, a light emitting unit 204, and a memory 207.

The memory 207 stores path information.

The wireless communication processing unit 202 receives a first frame that is transmitted from the first node apparatus 200-1 or the terminal 100 through the use of wireless communications, and transmits the received first frame to the second node apparatus 200-2 according to the path information. The wireless communication processing unit 202 also terminates the first frame received according to the path information.

The application processing unit 203 causes the light emitting unit 204 to emit light, based on first time information that is included in the first frame and that indicates timing to cause the light emitting unit 204 to emit light.

As such, in the second embodiment, the first frame transmits the plurality of node apparatuses 200-1, 200, 200-2, according to the path information. Then, the node apparatus 200 that receives the first frame is configured to cause the light emitting unit 204 to emit light based on the first time information, from the first frame, that indicates the timing to cause the light emitting unit 204 to emit light.

Therefore, since the light emitting unit 204 of the node apparatus 200 on a radio path emits light, other node apparatuses 200-1, 200-2 may also emit light, thereby making it possible to visualize a communication path of wireless communications. In addition, in the wireless network system 100, since the communication path of the wireless communications is visualized without removing or connecting a physical wire to the node apparatus 200, visualization is easily possible without incurring cost. Furthermore, it is possible to visualize a communication path of wireless communications by installing the plurality of node apparatuses 200-1, 20, 200-2, as a whole, in a variety of shapes, without installing a cable or the like. Accordingly, respective nodes 200, immediately after being installed in a concert venue or a wedding center and caused to emit light according to a communication path, may be installed in a different concert venue or a wedding center and caused to emit light, without separately removing or wiring a cable or the like. Therefore, the wireless network system 10 may be visualized with flexibility.

### OTHER EMBODIMENTS

The numerical values described in the first embodiments are an example. For example, numerical values detected by the acceleration sensor 205 or the timer 206 when an operating state of the node illustrated in FIG. 7B is detected may be any numerical value other than those described in the first embodiment. In addition, the time indicated in S304 of FIGS. 20, S403 and S408 of FIG. 25, and S504 of FIG. 31 may also be any time other than 5 seconds or 1 seconds.

In addition, the direction of the node 200 was described based on the battery indicator 216, as illustrated in FIG. 7A. For example, any part in the node 200 other than the batter indicator 216 may be used as a reference.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A node apparatus comprising:
a light emitting device;
a memory configured to store path information;
a processor configured to
execute a wireless communication processing that includes
receiving a first frame transmitted wirelessly from a first node apparatus or a terminal apparatus, the first frame including first time information indicating a timing to cause the light emitting device to emit light,
performing at least either one of processing to transmit wirelessly the received first frame to a second node apparatus according to the path information, and processing to terminate the received first frame according to the path information, and
execute an application processing that includes
causing the light emitting device to emit light, based on the first time information included in the first frame.

2. The node apparatus according to claim 1,
wherein the application processing includes causing the light emitting device to emit light, based on the first time information included in the first frame and a hop count representing the number of node apparatuses through which the frame has passed before reaching the node apparatus.

3. The node apparatus according to claim 2,
wherein the application processing includes causing the light emitting device to emit light after elapse of time obtained by multiplying the first time information by the hop count from when the node apparatus receives the frame.

4. The node apparatus according to claim 1,
wherein the first frame transmitted from a first node apparatus or a terminal apparatus further includes path illumination color information and destination illumination color information,
wherein the application processing includes, based on the path illumination color information and the destination illumination color information which are included in the first frame, causing the light emitting device to emit light in a color corresponding to the path illumination color information and the destination illumination color information, the path illumination color information representing a color in which a node apparatus on a path based on the path information emits light, and the destination illumination color information representing a color in which a node apparatus that is a final destination in the path information emits light.

5. The node apparatus according to claim 1,
wherein the first frame includes, in a payload area of the first frame, command type information that distinguishes the first frame from other frames, address information of a node apparatus that is a final destination in the path information, path illumination color information that represents a color in which a node apparatus on a path based on the path information emits light, destination illumination color information that represents a color in which the node apparatus which is the final destination in the path information emits light, and the first time information.

6. The node apparatus according to claim 1, further comprising:
an acceleration sensor; and
a timer,
wherein the application processing includes causing the light emitting device to emit light in a color corresponding to a direction in which the node apparatus is inclined, when it is detected based on numerical values detected by the acceleration sensor and the timer that the node apparatus is off a placement surface and that the node apparatus is inclined.

7. The node apparatus according to claim 6,
wherein the application processing includes notifying the wireless communication processing of a second frame when it is detected based on numerical values detected by the acceleration sensor and the timer that the node apparatus is placed on the placement surface while remaining inclined after causing the light emitting device to emit light, the second frame including second time information that indicates timing to cause the light emitting device of other node apparatus to emit light, and
wherein the wireless communication processing includes transmitting the second frame to the first node apparatus or the terminal apparatus according to the path information.

8. The node apparatus according to claim 1,
wherein the wireless communication processing includes
receiving from the second node apparatus a second frame including second time information that indicates timing to cause the light emitting device to emit light, and
transmitting the received second frame to the first node apparatus or the terminal apparatus according to the path information
wherein the application processing includes causing the light emitting device to emit light based on the second time information included in the second frame.

9. The node apparatus according to claim 7,
wherein the second frame includes in a payload area command type information that distinguishes the second frame from other frames, address information of the node apparatus, illumination color information that represents a color in which the light emitting device has emitted light, and the second time information.

10. The node apparatus according to claim 1, further comprising:
an acceleration sensor; and
a timer,
wherein the application processing includes disrupting transmission and reception of the first frame by the wireless communication processing if in the wireless communication processing, a third frame is received from the terminal apparatus or the first node apparatus, the third frame requesting a change of a demonstration pattern from a first pattern to a second pattern,
wherein the application processing includes causing the light emitting device to emit light in a color corresponding to a direction in which the node apparatus is shaken, when it is detected based on numerical values detected by the acceleration sensor and the timer that the node apparatus is off a placement surface and that the node apparatus is shaken.

11. The node apparatus according to claim 10,
wherein the application processing includes notifying the wireless communication processing of a fourth frame when it is detected based on numerical values detected by the acceleration sensor and the timer that the node apparatus is placed on a placement surface, after causing the light emitting device to emit light, the fourth frame including third time information that indicates timing to cause a light emitting device of other node apparatus to emit light,
wherein the wireless communication processing includes broadcasting the fourth frame.

12. The node apparatus according to claim 10,
wherein the wireless communication processing includes when a fourth frame including third time information is received from the first or the second node apparatus, performing any one of first processing to broadcast the received fourth frame and second processing to terminate the fourth frame, the third time information indicating timing to cause the light emitting device to emit light,
wherein the application processing includes causing the light emitting device to emit light based on the third time information included in the fourth frame.

13. The node apparatus according to claim 11,
wherein the fourth frame includes in a payload area command type information that distinguishes the fourth frame from other frames, address information of the node apparatus, illumination color information that represents a color in which the light emitting device has emitted light, and the second time information.

14. The node apparatus according to claim 1, further comprising:
an acceleration sensor and
a timer,
wherein the application processing includes disrupting transmission and reception of the first frame by the wireless communication processing, when a third frame is received from the terminal apparatus or the first node apparatus, in the wireless communication processing, the third frame requesting change of a demonstration pattern from a first pattern to a third pattern,
wherein the application processing includes causing the light emitting device to emit light in a color corresponding to a direction in which the node apparatus is inclined, when it is detected based on numerical values detected by the acceleration sensor and the timer that the node apparatus is off a placement surface and that the node apparatus is inclined.

15. The node apparatus according to claim 14,
wherein the application processing includes notifying the wireless communication processing of a fifth frame when it is detected based on numerical values detected by the acceleration sensor and the timer that the node apparatus is placed on a placement surface while remaining inclined after causing the light emitting device to emit light, the fifth frame including fourth time information indicating timing to cause the light emitting device of other node to emit light and information indicating a type of demonstration corresponding to the direction in which the node apparatus is inclined,
wherein the wireless communication processing includes broadcasting the fifth frame.

16. The node apparatus according to claim 14,
wherein the wireless communication processing includes when a fifth frame is received from the first or the second node apparatus, performing any one of first processing to broadcast the received fifth frame and second processing to terminate the fifth frame, the fifth frame including information representing a type of demonstration and fourth time information indicating timing to cause the light emitting device to emit light,
wherein the application processing includes causing the light emitting device to emit light based on the information representing the type of demonstration and the fourth time information.

17. The node apparatus according to claim 16,
wherein a direction in which a first part placed on a surface of the node apparatus faces is a front direction, and an axis on a horizontal plane parallel to the front direction is an X-axis,
wherein the application processing includes causing the light emitting device to emit light based on information representing the type of demonstration, the fourth time information included in the fifth frame, and a distance in a direction of the X-axis between other node apparatus that has generated the fifth frame and the node apparatus.

18. The node apparatus according to claim 16,
wherein a direction in which a first part placed on a surface of the node apparatus faces is a front direction, an axis on a horizontal plane parallel to the front direction is an X-axis, and an axis on a horizontal plane perpendicular to the X-axis is a Y-axis,
wherein the application processing includes causing the light emitting device to emit light based on information representing the type of demonstration, the fourth time information included in the fifth frame, and distances in the directions of the X-axis and in a direction of the Y-axis between other node apparatus that has generated the fifth frame and the node apparatus.

19. The node apparatus according to claim 15,
wherein the fifth frame includes in a payload area command type information that distinguishes the fifth frame from other frame, address information of the node apparatus, pattern information that indicates a pattern of demonstration, illumination color information that represents a color in which the light emitting device has emitted light, the fourth time information, and repetition number information that indicates the number of times to repeat the demonstration.

20. The node apparatus according to claim 10,
wherein the third frame includes in a payload area command type information that distinguishes the third frame from other frame, address information of a node apparatus that is a final destination in the path information, address information of a node apparatus that received the third frame transmitted from the terminal apparatus, pattern information that represents the third pattern, and filter type information that represents permission or refusal of wireless communications with a certain node apparatus surrounding the node apparatus.

21. The node apparatus according to claim 1,
wherein the wireless communication processing includes
receiving a sixth frame transmitted from the first node apparatus or the terminal apparatus, and
performing any one of first processing to transmit the received sixth frame to the second node apparatus according to the path information or second processing to terminate the received sixth frame according to the path information,
wherein the application processing includes restarting the node apparatus based on restart delay time included in the sixth frame, after the restart delay time elapses from receipt of the sixth frame.

22. A wireless network system comprising:
a terminal apparatus; and
a plurality of node apparatuses,
wherein each of the node apparatuses includes
a light emitting device, and
a memory configured to store path information,
a processor configured to
execute a wireless communication processing that includes
receiving a first frame transmitted wirelessly from a first node apparatus or a terminal apparatus, the first frame including first time information indicating a timing to cause the light emitting device to emit light, and
performing at least either one of processing to utilize the wireless communications to transmit the received first frame to a second node apparatus according to the path information and processing to terminate the received first frame according to the path information, and
execute an application processing that includes
causing the light emitting device to emit light, based on the first time information included in the first frame.

23. A method, performed by a node apparatus, for visualization of a communication path, comprising:
executing, by a processor of the node apparatus, a wireless communication processing that includes
receiving a first frame transmitted wirelessly from a first node apparatus or a terminal apparatus, the first frame including first time information indicating a timing to cause the light emitting device to emit light, and
performing at least either one of processing to utilize the path information to transmit the received first frame to a second node apparatus according to the path information and processing to terminate the received first frame according to the path information;
executing, by the processor of the node apparatus, an application processing that includes
causing the light emitting device to emit light, based on the first time information included in the first frame.
